(19) United States
(12) Patent Application Publication
(10) Pub. No.: US 2026/0283436 A1
(43) Pub. Date: Sep. 24, 2026

(54) ROBOT CLEANER AND ROBOT CLEANER SYSTEM

(71) Applicant: LG ELECTRONICS INC., Seoul (KR)

(72) Inventors: Daeho CHANG, Seoul (KR); Ingyu YANG, Seoul (KR); Donggeun LEE, Seoul (KR)

(73) Assignee: LG ELECTRONICS INC., Seoul (KR)

(21) Appl. No.: 19/458,298

(22) Filed: Jan. 23, 2026

(30) Foreign Application Priority Data
Jan. 24, 2025 (KR) 10-2025-0010834

(51) Int. Cl. A47L 11/40; F26B 3/02

(52) U.S. Cl. CPC A47L 11/4091; A47L 11/4036; A47L 11/4055; F26B 3/02; A47L 2201/028

(57) ABSTRACT

The present disclosure relates to a robot cleaner system including a robot cleaner station including a housing, a seating part disposed in the housing and including a washing plate on which a robot cleaner is seated, a rag washing part configured to wash a rag of the robot cleaner, and a rag drying part configured to dry the rag of the robot cleaner, and a robot cleaner including a body, a rotary plate rotatably coupled to a lower side of the body, and the rag detachably coupled to the rotary plate, in which the rotary plate rotates while the rag drying part operates, thereby uniformly drying the rag of the robot cleaner.

### CROSS-REFERENCE TO RELATED APPLICATION

The present application claims priority to Korean Patent Application No. 10-2025-0010834, filed on Jan. 24, 2025, the entire contents of which are incorporated herein for all purposes by this reference.

### BACKGROUND OF THE DISCLOSURE

### Field of the Disclosure

The present disclosure relates to a robot cleaner and a robot cleaner system, and more particularly, to a robot cleaner and a robot cleaner system that may collect dust from a dust bin of the robot cleaner and wash and dry a rag of the robot cleaner when the robot cleaner is coupled.

### Description of the Related Art

Recently, with the advancement of industrial technologies, robot cleaners, which clean zones required to be cleaned while autonomously traveling without user operations, have been developed.

The robot cleaner may be equipped with a sensor capable of recognizing a space to be cleaned, an agitator capable of cleaning and sweeping a floor surface, and a rag or the like capable of wiping the floor surface. The robot cleaner may travel while sucking dust from the floor surface in the space recognized by the sensor and wiping the floor surface with the rag or the like.

Among the robot cleaners, there are a dry robot cleaner capable of sucking and removing debris scattered on the floor surface, and a wet robot cleaner capable of wiping the floor surface with the rag containing moisture in order to effectively remove debris attached to the floor surface. The dry robot cleaner is equipped with a dust bin and sucks debris on the floor surface by using a suction force of a suction motor. The wet robot cleaner is equipped with a water container and is configured such that water accommodated in the water container is supplied to the rag and the rag containing moisture wipes the floor surface to effectively remove debris attached to the floor surface. In addition, there is also a robot cleaner having a shape equipped with both the agitator and the rag.

A charging stand for the robot cleaner refers to a device in which the robot cleaner, which has completed a cleaning process, is docked. The charging stand is configured to charge a battery provided in the robot cleaner by supplying electric power to the battery. The charging stand is equipped with a power supply module therein. The charging stand is equipped with a charging terminal connected to the power supply module, and the robot cleaner is equipped with a corresponding terminal. In case that the charging terminal and the corresponding terminal come into contact with each other, electric power is supplied to the battery, and the battery is charged.

Meanwhile, in case that the charging stand for the robot cleaner is disposed in a building, the charging stand occupies a predetermined range of an indoor space. In this case, spatial efficiency of the interior may deteriorate. In addition, there may be a risk that the robot cleaner may collide with a user or pet while the user or pet is moving, which causes injury or damage to both the user or pet and the robot cleaner.

In addition, in the case of a station to which a dust collection function of the robot cleaner is added, there is a limitation in that a volume occupied by the station increases, which may degrade the aesthetics of the interior.

Meanwhile, a robot cleaner station may be provided with a hot air supply module configured to dry a rag of a robot cleaner.

In this regard, CN 217090594 U discloses a station that dries a wet rag attached to a rag plate of a robot cleaner by using a flow of hot air.

In the above-mentioned station, a rib formed on a washing plate is formed with an air outlet that discharges air.

However, a case in which hot air is discharged from a part of the washing plate, as described above, has a limitation in that the hot air cannot be uniformly supplied to the wet rag. As a result, there is a problem in that a large amount of time is required to completely dry the rag, which degrades energy efficiency.

In addition, in case that the drying process is performed over a long period of time to dry the entire rag, there is a problem in that a specific portion is rather excessively dried, which causes damage to the rag.

### SUMMARY OF THE DISCLOSURE

The present disclosure is proposed to solve these problems with the robot cleaner and the robot cleaner system in the related art and aims to provide a robot cleaner system capable of automatically washing and drying a rag of a robot cleaner.

The present disclosure also aims to provide a robot cleaner system capable of improving efficiency related to energy and time required to dry a rag of a robot cleaner.

The present disclosure also aims to provide a robot cleaner system capable of preventing a rag of a robot cleaner from being non-uniformly dried.

In order to achieve the above-mentioned objects, a robot cleaner system according to the present disclosure includes: a robot cleaner station including a housing, a seating part disposed in the housing and including a washing plate on which a robot cleaner is seated, a rag washing part configured to wash a rag of the robot cleaner, and a rag drying part configured to dry the rag of the robot cleaner; and a robot cleaner including a body, a rotary plate rotatably coupled to a lower side of the body, and the rag detachably coupled to the rotary plate, in which the rotary plate rotates while the rag drying part operates.

In this case, the rotary plate may move upward while the rag drying part operates.

Meanwhile, the rag drying part may include: an outside air inlet port through which air existing outside the housing is introduced; a heater configured to heat the air introduced through the outside air inlet port; and an outside air outlet port through which the air heated by the heater is discharged to the rag, and the rotary plate may rotate while the heater operates.

In addition, the rag drying part may further include a blower fan configured to provide a flow force to the air introduced through the outside air inlet port, and the rotary plate may rotate while the blower fan operates.

In addition, the rag drying part may further include an air discharge fan configured to provide a flow force to air introduced through an air suction port, and the rotary plate may rotate while the air discharge fan operates.

Meanwhile, the robot cleaner station may further include a humidity sensor configured to measure humidity, the rag drying part may further include: an air suction port disposed in the housing and configured to suck air inside the housing; and an air discharge duct through which the air sucked through the air suction port flows, and the humidity sensor may be disposed in the air discharge duct.

In this case, the rotation of the rotary plate may be stopped when a rate of change in humidity measured by the humidity sensor is a preset reference value or less.

Meanwhile, the robot cleaner station may be configured such that the rag drying part operates after the rag washing part operates, and the rotary plate rotates while the rag washing part operates.

In this case, a height of the rotary plate while the rag drying part operates may be higher than a height of the rotary plate while the rag washing part operates.

In addition, the robot cleaner station may further include a turbidity sensor configured to measure turbidity of a liquid, and a rotation time of the rotary plate may increase when the turbidity measured by the turbidity sensor is a preset reference value or more.

In this case, the rag washing part includes a regulator configured to adjust a flow rate of a liquid supplied from a water supply pipe, and the rotary plate may rotate while the regulator operates.

The rag may be positioned above the washing plate of the robot cleaner station and configured to rotate while heated air is introduced.

The rag may move upward when the heated air is introduced.

According to the robot cleaner system according to the present disclosure described above, the rotary plate may rotate during the process of drying the rag of the robot cleaner, thereby uniformly drying the entire rag.

In addition, the rag rotates in the state in which the rotary plate is moved downward during the process of washing the rag, and the rotary plate is moved upward during the process of drying the rag, thereby improving washing and drying efficiency.

In addition, the rag may rotate by 180 degrees in a predetermined cycle, such that the rag of the robot cleaner may be uniformly dried.

In addition, it is possible to prevent a problem, such as microorganism proliferation, caused when a part of the rag is not completely dried.

In addition, it is possible to improve energy efficiency by shortening the amount of time required to completely dry the rag.

### BRIEF DESCRIPTION OF THE DRAWINGS

FIG. 1 is a view for explaining a state in which a cleaner system according to an embodiment of the present disclosure is installed below a kitchen cabinet.

FIG. 2 is a view for explaining a relationship in which a pipe of the cleaner system according to the embodiment of the present disclosure is connected to a water drain pipe.

FIG. 3 is a perspective view for explaining the cleaner system according to the embodiment of the present disclosure.

FIG. 4 is a top plan view of FIG. 3.

FIG. 5 is a perspective view for explaining a robot cleaner according to the embodiment of the present disclosure.

FIG. 6 is a side view of FIG. 5.

FIG. 7 is a bottom plan view of FIG. 5.

FIG. 8 is a rear view of FIG. 5.

FIGS. 9A and 9B are views for explaining states in which a rotary plate is moved upward and downward in the robot cleaner according to the embodiment of the present disclosure.

FIG. 10 is a perspective view for explaining a structure of a robot cleaner station according to the embodiment of the present disclosure.

FIG. 11 is a perspective view for explaining a door part of the robot cleaner station according to the embodiment of the present disclosure.

FIG. 12 is a front view of FIG. 11.

FIG. 13 is a perspective view for explaining an internal structure of the robot cleaner station according to the embodiment of the present disclosure.

FIG. 14 is a top plan view of FIG. 13.

FIGS. 15 and 16 are views for explaining a washing plate and a washing tub of the robot cleaner station according to the embodiment of the present disclosure.

FIG. 17 is a view for explaining a dust collection part of the robot cleaner station according to the embodiment of the present disclosure.

FIG. 18 is a view for explaining a dust collection motor and a dust collection motor housing of the robot cleaner station according to the embodiment of the present disclosure.

FIG. 19 is an enlarged view for explaining a dust collection flow path and a return flow path in the robot cleaner station according to the embodiment of the present disclosure.

FIG. 20 is a cross-sectional view taken along line A-A in FIG. 14 and explaining a flow path of the dust collection part.

FIG. 21 is a cross-sectional view taken along line B-B in FIG. 14 and explaining the flow path of the dust collection part.

FIG. 22 is an enlarged view for explaining a rag washing part of the robot cleaner station according to the embodiment of the present disclosure.

FIG. 23 is an enlarged view for explaining a washing water supply part of the rag washing part of the robot cleaner station according to the embodiment of the present disclosure.

FIG. 24 is a cross-sectional view for explaining a washing water nozzle of the rag washing part of the robot cleaner station according to the embodiment of the present disclosure.

FIG. 25 is a view for explaining a detergent container of the robot cleaner station according to the embodiment of the present disclosure.

FIGS. 26 and 27 are views for explaining an outside air supply module of the robot cleaner station according to the embodiment of the present disclosure.

FIG. 28 is a top plan view for explaining an air discharge part of the robot cleaner station according to the embodiment of the present disclosure.

FIG. 29 is a cross-sectional view for explaining a route of air that flows to dry a rag in the robot cleaner station according to the embodiment of the present disclosure.

FIG. 30 is a view for explaining an air discharge port of the robot cleaner station according to the embodiment of the present disclosure.

FIG. 31 is a view for explaining a state in which a drawer is provided in the robot cleaner station according to the embodiment of the present disclosure.

FIG. 32 is a block diagram for explaining a control configuration of the robot cleaner station according to the embodiment of the present disclosure.

FIG. 33 is a flowchart for explaining a method of controlling the robot cleaner station according to the embodiment of the present disclosure.

FIG. 34 is a flowchart for explaining a method of controlling the robot cleaner system according to another embodiment of the present disclosure.

### DETAILED DESCRIPTION OF THE DISCLOSURE

Hereinafter, exemplary embodiments of the present disclosure will be described in detail with reference to the accompanying drawings.

The present disclosure may be variously modified and may have various embodiments, and particular embodiments illustrated in the drawings will be specifically described below. The description of the embodiments is not intended to limit the present disclosure to the particular embodiments, but it should be interpreted that the present disclosure is to cover all modifications, equivalents and alternatives falling within the spirit and technical scope of the present disclosure.

In the description of the present disclosure, the terms such as “first” and “second” may be used to describe various constituent elements, but the constituent elements may not be limited by the terms. These terms are used only to distinguish one constituent element from another constituent element. For example, a first component may be named a second component, and similarly, the second component may also be named the first component, without departing from the scope of the present disclosure.

The term “and/or” may include any and all combinations of a plurality of the related and listed items.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

The terminology used herein is used for the purpose of describing particular embodiments only and is not intended to limit the present disclosure. Singular expressions may include plural expressions unless clearly described as different meanings in the context.

The terms “comprises,” “comprising,” “includes,” “including,” “containing,” “has,” “having” or other thereof are inclusive and therefore specify the presence of stated features, integers, steps, operations, elements, components, and/or combinations thereof, but do not preclude the presence or addition of one or more other features, integers, steps, operations, elements, components, and/or combinations thereof.

Unless otherwise defined, all terms used herein, including technical or scientific terms, may have the same meaning as commonly understood by those skilled in the art to which the present disclosure pertains. The terms such as those defined in a commonly used dictionary may be interpreted as having meanings consistent with meanings in the context of related technologies and may not be interpreted as ideal or excessively formal meanings unless explicitly defined in the present application.

Further, the following embodiments are provided to more completely explain the present disclosure to those skilled in the art, and shapes and sizes of elements illustrated in the drawings may be exaggerated for a more apparent description.

### Kitchen Cabinet and Cleaner System

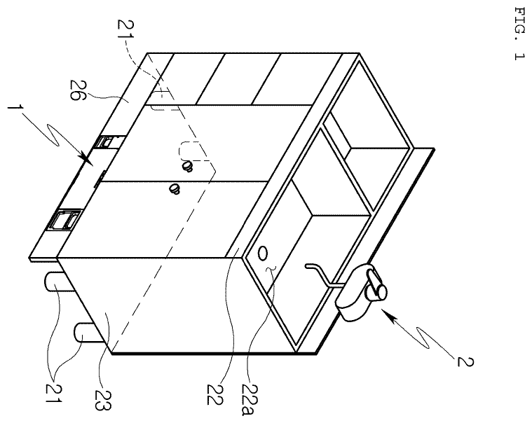

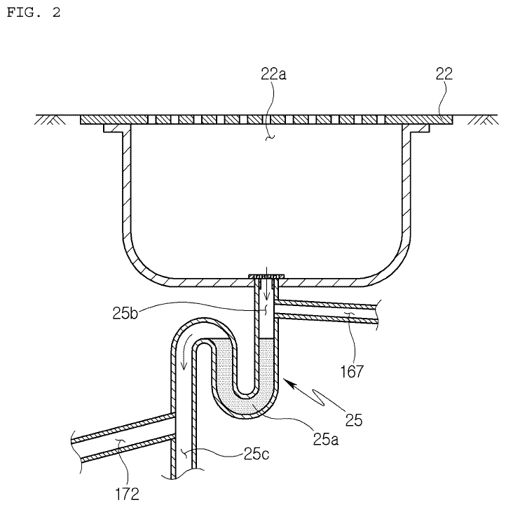

FIG. 1 is a view for explaining a state in which a cleaner system according to an embodiment of the present disclosure is installed below a kitchen cabinet, and FIG. 2 is a view for explaining a relationship in which a pipe of the cleaner system according to the embodiment of the present disclosure is connected to a water drain pipe.

With reference to FIGS. 1 and 2, a cleaner system 1 according to an embodiment of the present disclosure may be provided below a kitchen cabinet 2. Specifically, the kitchen cabinet 2 may be disposed in a kitchen and provide a space in which dishes, plates, cups, and the like may be accommodated and food preparation or dishwashing may be performed.

In addition, the kitchen cabinet 2 may be equipped with an upper plate (worktop) capable of serving as a sink, a cooking stage, or a working stage.

For example, the kitchen cabinet 2 may include a sink configured to provide a space in the upper plate so that dishwashing may be performed. Alternatively, the kitchen cabinet 2 may include a cooking stage on which food preparation is performed. In addition, the kitchen cabinet 2 may include a gas range stage on the upper plate on which a gas range, an induction cooktop, a halogen hob, an oven, or the like is installed.

In general, a standard cabinet having a width of 600 mm in a forward/rearward direction and a width of 600 mm in a leftward/rightward direction may be used as the kitchen cabinet 2.

The cleaner system 1 according to another embodiment of the present disclosure may be provided below a structure including at least any one of a water supply pipe and a water drain pipe. Specifically, the water supply pipe may refer to a flow path connected to an external water supply source configured to supply a fluid to the structure, and the water drain pipe may refer to a flow path configured to discharge a fluid, which is discharged from the structure, to a sewage system.

A storage cabinet configured to store dishes, kitchen tools, and the like may be provided below the kitchen cabinet 2 or the structure. That is, the kitchen cabinet 2 or the structure may include an upper plate 22 configured to provide a space in which tasks such as cooking or dishwashing may be performed, a lower plate 23 disposed to be spaced apart from a ground surface by a predetermined height, and an accommodation space formed between the upper plate 22 and the lower plate 23 and configured to accommodate dishes, kitchen tools, and the like. In this case, in case that the kitchen cabinet 2 is a sink, a basin 22a may be disposed in the upper plate 22.

In addition, the lower plate 23 may be supported by pedestals 21. The pedestals 21 may be disposed in a direction perpendicular to a floor of the kitchen and support a load of the kitchen cabinet 2. In this case, a space may be formed between the floor of the kitchen and the lower plate 23 in accordance with heights of the pedestals 21.

On the contrary, the kitchen cabinet 2 may be fixed to a wall of a building without the pedestal 21. Even in this case, a space may be formed between the floor of the kitchen and the lower plate 23.

The cleaner system 1 according to the embodiment of the present disclosure is mounted in a space (hereinafter, referred to as a ‘mounting space’) between the floor of the kitchen and the lower plate 23, as described above.

For example, the mounting space may have a height of 200 mm or less, and generally, a height of 160 mm or less.

Therefore, according to the present disclosure, the cleaner system 1 is disposed in a lower space of the kitchen cabinet 2, which minimizes a degree to which the cleaner system 1 is exposed to the outside.

In addition, the cleaner system 1 does not occupy a separate space in comparison with a case in which a charging stand for a robot cleaner is disposed in a predetermined space of a living room, a room, or a kitchen. The cleaner system 1 is disposed in an unused space formed by the kitchen cabinet 2, thereby maximizing spatial efficiency.

Meanwhile, the kitchen cabinet 2 or the structure is equipped with a water drain pipe 25 capable of draining liquids used for cooking or water used for dishwashing. At least a part of the water drain pipe 25 may be disposed in the accommodation space formed between the upper plate 22 and the lower plate 23. In general, the water drain pipe 25 may be connected to a drain port formed in the basin 22a of the sink. The water drain pipe 25 includes a U-trap 25a configured to prevent a reverse flow of contaminated gas or offensive odor. The U-trap 25a may be disposed in the accommodation space. A liquid introduced through the drain port flows downward by gravity at an upstream side 25b of the U-trap and accumulates in the U-trap 25a. When the liquid accumulates so that a level of the liquid becomes equal to or higher than a preset predetermined level by the U-trap 25a, the liquid may flow downward along a downstream side 25c of the U-trap and be discharged to the sewage system.

The cleaner system 1 according to the embodiment of the present disclosure may wash and dry rags 242 of a robot cleaner 200 by using the above-mentioned water drain pipe 25.

In addition, although not illustrated, the kitchen cabinet 2 may be equipped with the water supply pipe. Fresh water (or purified water) may be supplied to the cleaner system 1 through the water supply pipe.

Hereinafter, a specific structure of the cleaner system 1 will be described.

### Cleaner System

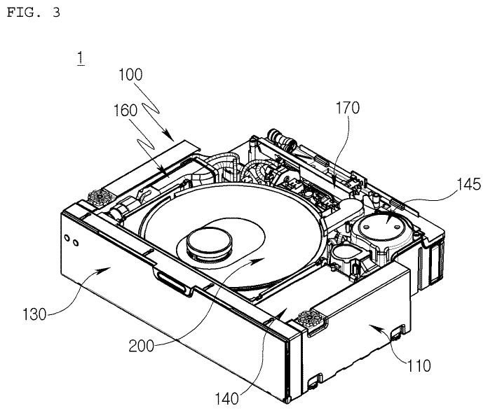

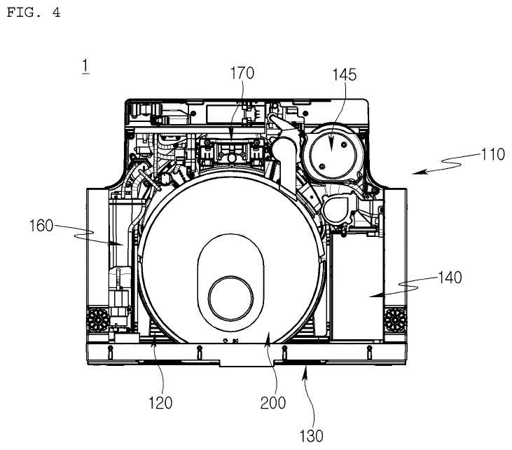

Meanwhile, FIGS. 3 and 4 are views for explaining the cleaner system according to the embodiment of the present disclosure.

The cleaner system 1 according to the embodiment of the present specification may include a robot cleaner station 100 and the robot cleaner 200.

The cleaner system 1 includes the robot cleaner station 100. The robot cleaner 200 may be coupled to the robot cleaner station 100. Specifically, the robot cleaner 200 may enter a front side of the robot cleaner station 100, and the robot cleaner 200 may be accommodated in the robot cleaner station 100. The robot cleaner station 100 may remove dust from a dust bin 220 of the robot cleaner 200. The robot cleaner station 100 may wash a rotary cleaning part 240 of the robot cleaner 200. The robot cleaner station 100 may dry the rotary cleaning part 240 of the robot cleaner 200. The robot cleaner station 100 may supply electric power to the robot cleaner 200.

### Robot Cleaner

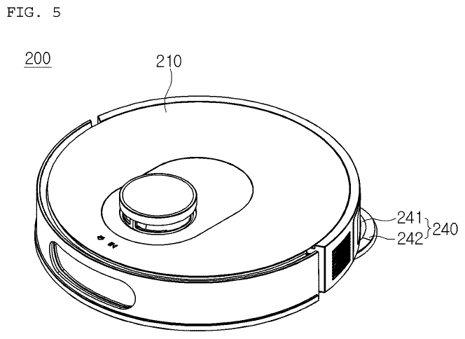

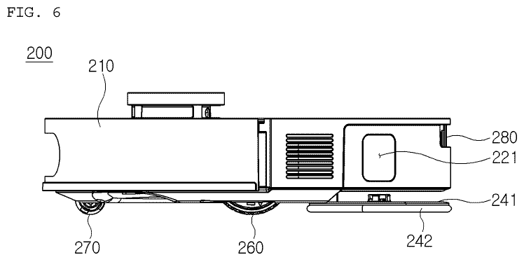

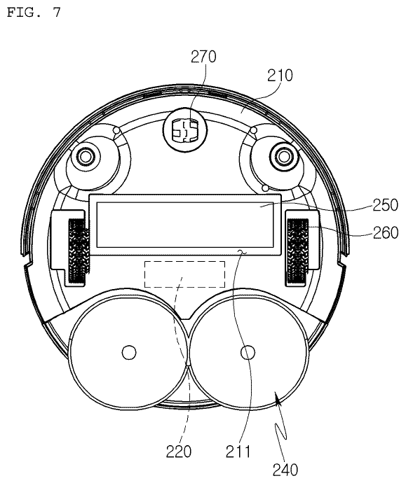

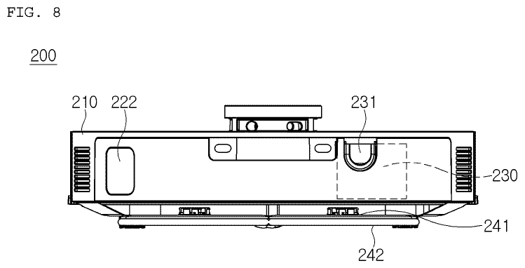

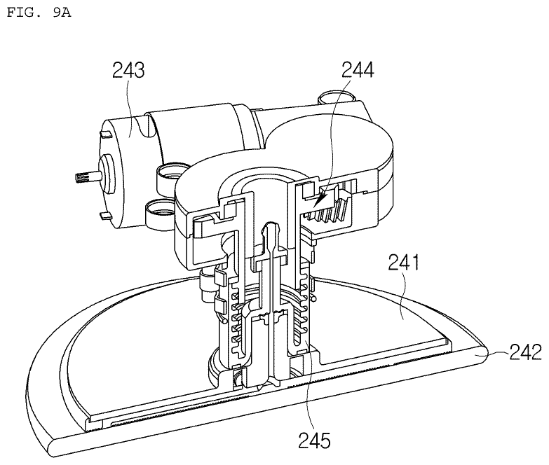

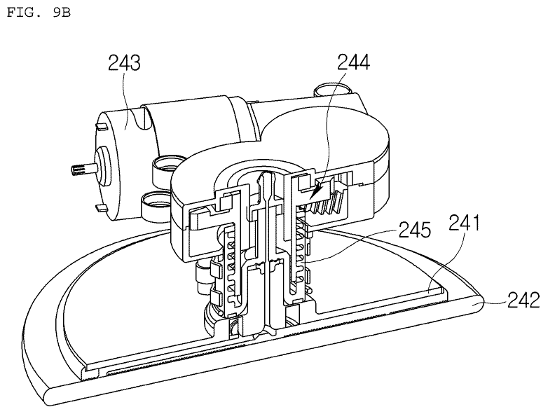

Meanwhile, FIGS. 5 to 9B are views for explaining the robot cleaner in the robot cleaner system according to the embodiment of the present disclosure.

A structure of the robot cleaner 200 will be described below with reference to FIGS. 5 to 9B.

The robot cleaner 200 may automatically clean a zone to be cleaned by sucking debris such as dust from a floor while autonomously traveling in the zone to be cleaned.

The robot cleaner 200 according to the embodiment of the present disclosure is configured to be placed on a floor and clean the floor while moving on a floor surface. Therefore, hereinafter, an upward/downward direction is defined based on a state in which the robot cleaner 200 is placed on the floor.

Further, based on a pair of wheels 260, a side at which an auxiliary wheel 270 to be described below is defined as a front side, and a side at which the rotary cleaning part 240 to be described below is disposed is defined as a rear side.

Among the portions described in the embodiment of the present disclosure, a ‘lowermost portion’ may be a portion positioned at a lowest position or a portion closest to the floor when the robot cleaner 200 according to the embodiment of the present disclosure is placed on the floor and used.

The robot cleaner 200 according to the embodiment of the present disclosure includes a body 210, the dust bin 220, a water container 230, the rotary cleaning part 240, an agitator 250, the wheels 260, the auxiliary wheel 270, and the charging terminal 280.

The body 210 may define an overall external shape of the robot cleaner 200. Components constituting the robot cleaner 200 may be coupled to the body 210, and some of the components constituting the robot cleaner 200 may be accommodated in the body 210.

Specifically, the components of the robot cleaner 200 may be provided in a space in the body 210. For example, a battery and at least one motor may be accommodated in the space in the body 210.

In the embodiment of the present disclosure, the body 210 has a shape in which a width (or diameter) in a horizontal direction is larger than a height in an upward/downward direction. The body 210 may provide an advantageous structure that assists the robot cleaner 200 in having a stable structure and allows the robot cleaner 200 to avoid an obstacle while moving traveling.

The body 210 may have various shapes such as a circular shape, an elliptical shape, or a quadrangular shape when viewed from above or below.

The body 210 may be divided into a lower body and an upper body, and the lower body and the upper body may be coupled to define the space in the body 210.

The lower body may be coupled to the upper body to define the space capable of accommodating therein the battery, at least one sensor, and at least one motor.

A suction part 211 into which air is introduced may be formed in the lower body, and a hole configured to accommodate the pair of wheels 260 may be formed in the lower body.

The suction part 211 may be a passageway into which dust on the floor surface is introduced. Further, the suction part 211 may communicate with a suction flow path (not illustrated) formed in the body 210, and the suction flow path may communicate with an internal space of the dust bin 220.

Meanwhile, the lower body may be further provided with an air discharge flow path. One side of the air discharge flow path may communicate with the internal space of the dust bin 220, and the other side of the air discharge flow path may communicate with an air discharge outlet. In this case, a filter may be disposed in the air discharge outlet.

With this configuration, the air introduced through the suction part 211 may flow into the dust bin 220 through the suction flow path and be discharged to the air discharge outlet through the air discharge flow path.

The agitator 250 to be described below may be rotatably accommodated in the suction part 211. With this configuration, dust present around the suction part 211 may be guided into the suction part 211 by a rotation of the agitator 250, thereby improving efficiency in sucking dust.

The upper body may define an external appearance of an upper side of the robot cleaner 200. Although not illustrated, a display may be provided on the upper body.

The robot cleaner 200 of the present disclosure may include a bumper. The bumper is coupled along a rim of the body 210 and configured to move relative to the body 210.

The bumper may be coupled along a part of the rim of the body 210 or coupled along the entire rim of the body 210. At least one elastic member (not illustrated) may be provided between the bumper and the body 210. With this configuration, when the bumper comes into contact with an obstacle or the like and relatively moves toward a center of the body 210, the bumper may be returned to an original position by a restoring force of the elastic member (not illustrated), and the elastic member (not illustrated) may absorb or disperse impact applied to the bumper to prevent and reduce the transmission of the impact to the body 210.

The dust bin 220 may be provided to suck outside dust and air and store dust.

The dust bin 220 may store dust that passes through the suction flow path and is introduced. The dust bin 220 may have a dust inlet port configured to communicate with the suction flow path, the internal space capable of storing dust, and an air discharge port through which air may be discharged.

The dust bin 220 may be provided in the body 210. In this case, the dust bin 220 may be fixedly coupled to the body 210. Of course, according to the embodiment, the dust bin 220 may be separably provided.

Meanwhile, in the present disclosure, a dust discharge flow path may be formed in the dust bin 220. The dust discharge flow path may allow the internal space of the dust bin 220 and an external space of the robot cleaner 200 to communicate with each other. With this configuration, in case that the robot cleaner station 100 collects dust, the dust in the dust bin 220 may be removed.

Meanwhile, a dust discharge port 221, which communicates with the dust discharge flow path, may be formed in the dust bin 220 according to the embodiment of the present disclosure. For example, the dust discharge port 221 may be formed at one side of a rear side of an outer surface (or outer peripheral surface) of the body 210. In another example, the dust discharge port 221 may be formed in an outer surface of the dust bin 220.

In addition, the robot cleaner 200 according to the embodiment of the present disclosure may have a dust bin door 222 configured to selectively open or close the dust discharge port 221. Specifically, the dust bin door 222 may be coupled to the body 210 and disposed at a position at which the dust bin door 222 may block the dust discharge port 221. For example, the dust bin door 222 may be made of rubber or resin and configured to be flipped, and one side of the dust bin door 222 may be fixedly coupled to the body 210.

With this configuration, when a dust collection motor 145 of the robot cleaner station 100 to be described below operates, the dust bin door 222 is elastically deformed by driving power of the dust collection motor 145, and the dust discharge port 221 is opened, such that the dust in the dust bin 220 may be collected by a dust collection part 140 of the robot cleaner station 100.

The water container 230 may be provided in the form of a container having an internal space to store therein a liquid such as water. The water container 230 may be disposed in the body 210 and fixedly coupled to the body 210 or detachably coupled to the body 210.

The water container 230 include a supply part 231 and a nozzle (not illustrated). The supply part 231 may be configured to supply a liquid such as water from the outside. For example, the supply part 231 may have an injection port formed at the other side of the rear side of the outer surface (or outer peripheral surface) of the body 210, and the supply part 231 may be connected to a storage space in the water container 230 through a water supply hose.

In this case, with a relationship with the dust discharge port 221, the supply part 231 may be disposed at a side opposite to the robot cleaner 200 in a leftward/rightward direction. For example, in case that the dust discharge port 221 is disposed at a rear left side of the body 210, the supply part 231 may be disposed at a rear right side of the body 210.

With the above-mentioned configuration, in the state in which the robot cleaner 200 is coupled to the robot cleaner station 100, the robot cleaner station 100 may perform both the dust collection and the water injection.

Meanwhile, the nozzle (not illustrated) is provided in the form of a tube or pipe and connected to the water container 230 so that the liquid in the water container 230 may flow through the interior of the nozzle. The nozzle (not illustrated) may be disposed such that one side thereof is connected to the water container 230, and the other end thereof is positioned above a pair of rotary plates 241 or positioned on each of the pair of rotary plates 241. Therefore, the liquid in the water container 230 may be supplied to the pair of rags 242.

That is, the nozzle (not illustrated) may be provided in a shape in which two tube portions are diverged from a single tube portion. In this case, an end of one diverged tube portion may be positioned above a left rag, and an end of the other diverged tube portion may be positioned above a right rag.

Meanwhile, although not illustrated, the water container 230 is equipped with a pump, and the pump may allow the water in the water container 230 to flow to the nozzle (not illustrated). Therefore, when the pump of the water container 230 operates, the liquid stored in the water container 230 may be discharged to the rotary cleaning part 240 through the nozzle (not illustrated).

The rotary cleaning part 240 includes the rotary plates 241 and the rags 242.

The rotary plates 241 may be provided as the pair of rotary plates 241 including a left rotary plate and a right rotary plate, and the rags 242 may be provided as the pair of rags 242 including the left rag and the right rag.

The rotary plate 241 may be rotatably disposed on a bottom surface of the body 210, and the rag 242 may be coupled to a lower side of the rotary plate 241.

The rotary plate 241 has a predetermined area and is provided in the form of a flat plate, a flat frame, or the like. The rotary plate 241 is laid approximately horizontally. Therefore, the rotary plate 241 has a shape in which a width (or diameter) thereof in the horizontal direction is sufficiently larger than a height thereof in the upward/downward direction. The rotary plate 241 coupled to the body 210 may be parallel to the floor surface or inclined with respect to the floor surface. The rotary plate 241 may have a circular plate-like shape, the bottom surface of the rotary plate 241 may have an approximately circular shape, and the rotary plate 241 may have a rotationally symmetrical shape as a whole.

The pair of rotary plates 241 may be vertically symmetric.

The rag 242 may be coupled to the lower side of the rotary plate 241 so as to face the bottom surface.

The rag 242 is configured such that a bottom surface of the rag 242 facing the floor has a predetermined area. The rag 242 has a flat shape. The rag 242 is configured such that a width (or diameter) thereof in the horizontal direction is sufficiently larger than a height of thereof in the upward/downward direction. When the rag 242 is coupled to the body 210, the bottom surface of the rag 242 may be parallel to the floor or inclined with respect to the floor.

The bottom surface of the rag 242 may have an approximately circular shape, and the rag 242 may have a rotationally symmetrical shape as a whole. In addition, the rag 242 may be attached to or detached from the bottom surface of the rotary plate 241. The rag 242 may be coupled to the rotary plate 241 and rotate together with the rotary plate 241.

Meanwhile, the rotary cleaning part 240 may be equipped with a drive part configured to apply a rotational force to the rotary plate 241. For example, the drive part may include a rotary plate motor 243, a rotary plate gear part 244, and a rotary plate shaft 245. Therefore, when the drive part operates, the rotary plates 241 and the rags 242 may rotate to wipe and clean the floor surface.

Meanwhile, in the present embodiment, the rotary plate 241 may be provided such that a height thereof is adjustable. Specifically, the rotary plate motor 243 may be configured to change a rotation direction. Therefore, the rotary plate 241 may move downward when the rotary plate motor 243 rotates in one preset direction, and the rotary plate 241 may move upward when the rotary plate motor 243 rotates in the other direction that is a direction opposite to one direction.

The rotary plate gear part 244 may transmit a rotational force of the rotary plate motor 243 to the rotary plate shaft 245.

The rotary plate gear part 244 may include a plurality of gears. For example, the rotary plate gear part 244 may include a worm gear coupled to a shaft of the rotary plate motor 243 and configured to rotate together with the shaft of the rotary plate motor 243, a connection gear configured to engage with the worm gear and rotate in conjunction with the worm gear, and a driven gear configured to engage with the connection gear and rotate. In this case, gear teeth may be formed on an outer peripheral surface of an upper side of the driven gear and engage with the connection gear, and a screw thread may be formed on an outer peripheral surface of a lower side of the driven gear.

In addition, the rotary plate shaft 245 may be formed in a cylindrical shape, and at least a part of the driven gear may be accommodated in the rotary plate shaft 245. In addition, a screw thread may be formed on an inner peripheral surface of the rotary plate shaft 245. In this case, the screw thread formed on the driven gear may rotate relative to the inner peripheral surface of the rotary plate shaft 245 and relatively move along the screw thread formed on the inner peripheral surface of the shaft 245.

Therefore, when the rotary plate motor 243 rotates in one preset direction, the driven gear may rotate in one direction, and the rotary plate shaft 245 may move downward. Further, after the driven gear moves to an inner upper end of the rotary plate shaft 245, the driven gear and the rotary plate shaft 245 may rotate together. That is, when the rotary plate motor 243 rotates in one direction, the rotary plate 241 may move downward and then rotate.

In contrast, when the rotary plate motor 243 rotates in the other direction, the driven gear may rotate in the other direction, and the rotary plate shaft 245 may move upward. Further, after the driven gear moves to an inner lower end of the rotary plate shaft 245, the driven gear and the rotary plate shaft 245 may rotate together. That is, when the rotary plate motor 243 rotates in the other direction, the rotary plate 241 may move upward and then rotate.

The agitator 250 may have a plurality of brushes configured to be rotatable and guide outside dust and air into the dust bin 220. In this case, the agitator 250 may be provided with at least one gear.

Meanwhile, the agitator 250 according to the present embodiment may be equipped with a separate agitator motor (not illustrated) to receive rotational power. According to the embodiment, the agitator 250 may also receive rotational power from a driving motor or receive rotational power from the drive part of the rotary cleaning part 240.

The wheels 260 may be provided on the bottom surface of the body 210 and connected to the drive part (not illustrated). In this case, the drive part (not illustrated) may be coupled to the body 210.

The wheels 260 may be provided on the body 210 and roll on the floor.

The wheels 260 may include a first driving wheel and a second driving wheel. In this case, the first driving wheel may be identical to the second driving wheel, or the first driving wheel and the second driving wheel may be symmetric. For example, in case that the first driving wheel is positioned at the left side of the robot cleaner 200, the second driving wheel may be positioned at the right side of the robot cleaner 200. In this case, the first driving wheel and the second driving wheel may be symmetric vertically.

The drive part (not illustrated) may include driving motors and gears. In this case, the driving motors may be accommodated in the body 210 and provide power to the wheels 260. The driving motors may include a first driving motor and a second driving motor.

The driving motor may be configured as an electric motor. The plurality of gears engage with one another and rotate. The plurality of gears connect the driving motors and the wheels 260 and transmit rotational power of the driving motors to the wheels 260. Therefore, the wheels 260 may rotate when rotary shafts of the driving motors rotate.

With this configuration, when the driving motors operate, the wheels 260 may rotate, and the body 210 may travel on the floor surface at a predetermined traveling speed.

The auxiliary wheel 270 may be provided on a lower surface of the body 210 and roll on the floor surface (cleaning target surface). The auxiliary wheel 270, together with the pair of wheels 260, may support the body 210 on the floor surface. With this configuration, the auxiliary wheel 270 may guide a motion of the robot cleaner 200 while minimizing friction between the robot cleaner 200 and the floor surface.

The suction motor (not illustrated) may generate a suction force capable of sucking outside dust and air through the suction part 211. For example, the suction motor (not illustrated) may be an electric motor. By the suction force generated by the suction motor (not illustrated), outside dust and air may be introduced into the suction part 211 and reach the dust bin 220 after passing through the suction flow path.

Although not illustrated, the battery is coupled to the body 210 and configured to supply electric power to other components constituting the robot cleaner 200. The battery may supply electric power to at least one motor provided in the robot cleaner 200. For example, the battery may supply electric power to the motors provided in the rotary cleaning part 240, the agitator 250, the wheel 260, and the suction motor (not illustrated).

In addition, the battery may supply electric power to a sensor part (not illustrated) and a controller (not illustrated).

The battery may be charged with external electric power. To this end, the charging terminal 280 for charging the battery may be provided at one side of the body 210. For example, the charging terminal 280 may be disposed at a rear side of the outer surface of the body 210. The charging terminal 280 may be supplied with electric power by coming into contact with an electric power supply terminal 123b of the robot cleaner station 100 when the robot cleaner 200 is coupled to the robot cleaner station 100.

### Robot Cleaner Station

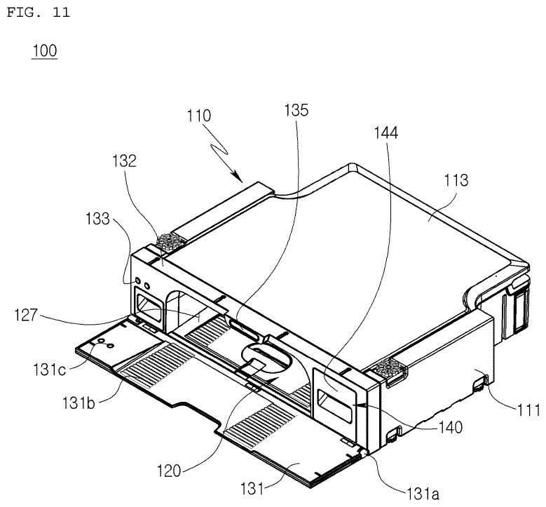

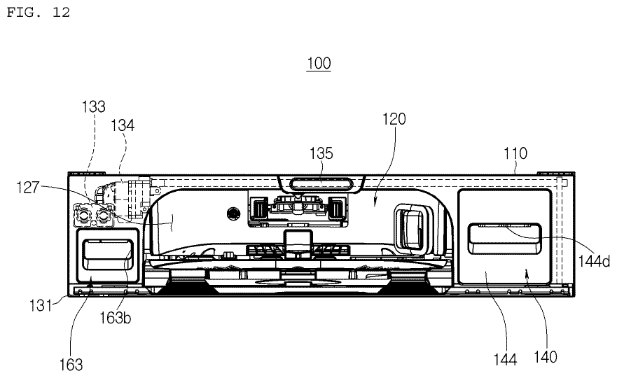

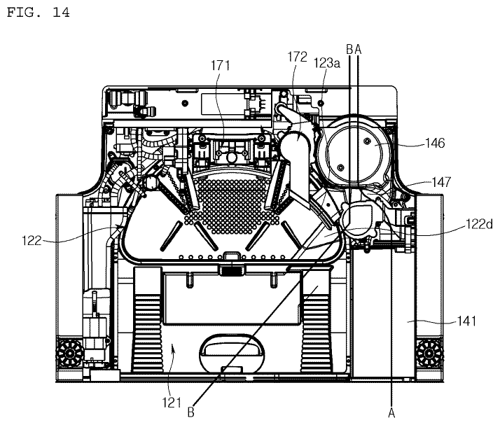

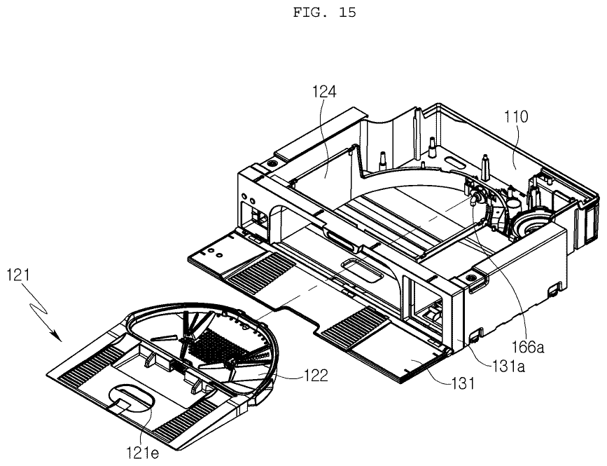

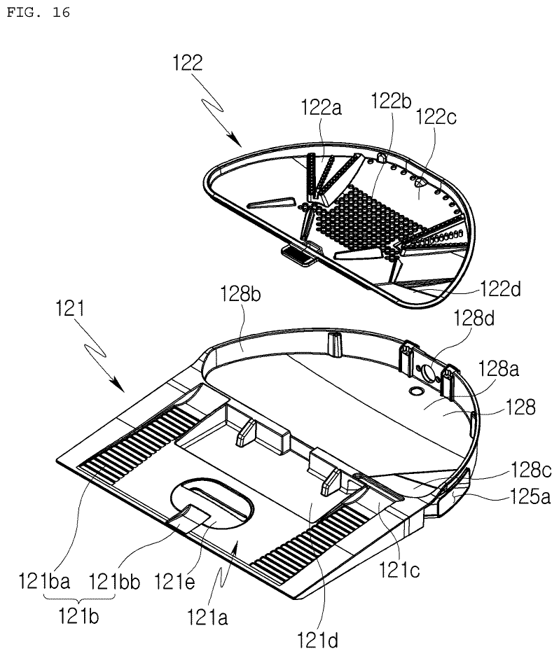

The robot cleaner station 100 of the present disclosure will be described below with reference to FIGS. 3 to 16.

The robot cleaner 200 may be accommodated in the robot cleaner station 100. The robot cleaner 200 may be coupled to a seating part 120 of the robot cleaner station 100.

The robot cleaner station 100 may include a housing 110.

The housing 110 may define an external appearance of the robot cleaner station 100. For example, the housing 110 may be formed in a shape similar to a hexahedral shape including at least one outer wall surface.

The housing 110 may be formed with a space in which the seating part 120, a door part 130, the dust collection part 140, a rag washing part 160, and a drying part 170 may be accommodated.

The housing 110 may be mounted below the kitchen cabinet 2. Specifically, the housing 110 may be installed in a mounting space formed between the lower plate 23 of the kitchen cabinet 2 and the floor of the kitchen.

The housing 110 includes a pair of outer walls 111 provided to face each other. The outer wall 111 may refer to a surface formed in a gravitational direction.

For example, the pair of outer walls 111 may be installed below the kitchen cabinet 2 at predetermined intervals. In this case, the housing 110 may further include a bottom surface 112 facing the floor of the kitchen, and the pair of outer walls 111 may be connected through the bottom surface 112. Meanwhile, the housing 110 may further include an upper cover 113 facing the lower plate 23 of the kitchen cabinet 2, and the upper cover 113 may be separably coupled to upper ends of the pair of outer walls 111. Therefore, it is possible to prevent the constituent components of the robot cleaner 200 and the robot cleaner station 100 from being contaminated even in case that debris falls downward from the kitchen cabinet 2. In addition, the housing 110 may further include a rear surface 115 facing the wall of the building. With this configuration, the constituent components of the robot cleaner station 100 may be accommodated in the housing 110 (between the pair of outer wall surfaces).

In addition, the robot cleaner 200 may be accommodated in the housing 110. The housing 110 may be disposed such that the pair of outer walls 111 have an interval larger than a maximum width of the robot cleaner 200 in the horizontal direction. With this configuration, the robot cleaner 200 may enter or exit the interior of the housing 110.

In this case, in the present embodiment, the robot cleaner 200 may enter or exit the front side of the robot cleaner station 100. In this case, the front side may refer to a direction in which a door 131 is provided based on the interior of the robot cleaner station 100.

In addition, the rear side may refer to a direction opposite to the front side based on the interior of the robot cleaner station 100. For example, the wall (not illustrated) of the building may be disposed rearward of the robot cleaner station 100.

In addition, the left side may be referred to as a leftward side and the right side may be referred to as a rightward side when the front side is viewed from the interior of the robot cleaner station 100.

That is, the outer walls 111 of the robot cleaner station 100 may be respectively disposed at the left side and the right side.

Therefore, the upper side of the housing 110 may be covered by the kitchen cabinet 2, and the lower side of the housing 110 may be covered by the floor of the kitchen. In addition, the left and right surfaces of the housing 110 are kept covered by the outer walls, and the housing 110 is disposed below the kitchen cabinet 2. In this case, the lower portion of the kitchen cabinet 2, which excludes the robot cleaner station 100, is finished by a baseboard 26. As a result, only the front surface of the housing 110 may be exposed to the outside.

Therefore, it is possible to minimize a degree to which the robot cleaner station 100 and the robot cleaner 200 are exposed to the outside.

With this configuration, the robot cleaner station 100 of the present disclosure may provide an aesthetic appearance to a user in terms of interior aesthetics.

### Layout

The robot cleaner station 100 according to the embodiment of the present disclosure is characterized by being installed in the lower space of the kitchen cabinet 2.

To this end, the robot cleaner station 100 according to the embodiment of the present disclosure is characterized by being disposed in the horizontal direction in accordance with a space formed between the lower plate 23 of the kitchen cabinet 2 and the floor of the kitchen.

Specifically, in the robot cleaner station 100 according to the embodiment of the present disclosure, the dust collection part 140 and/or the rag washing part 160 may be disposed on a lateral surface of an inlet/outlet 127.

In this case, in case that both the dust collection part 140 and the rag washing part 160 are provided, the seating part 120 may be disposed between the dust collection part 140 and the rag washing part 160.

For example, the inlet/outlet 127 and the door 131 may be disposed at the front side of the robot cleaner station 100. Further, the seating part 120 to which the robot cleaner 200 is coupled may be disposed rearward of the inlet/outlet 127. In this case, the dust collection part 140 may be disposed rearward by a predetermined length from a front end of the robot cleaner station 100. In addition, the rag washing part 160 may be disposed rearward by a predetermined length from the front end of the robot cleaner station 100.

Therefore, when the robot cleaner station 100 is viewed from a front outer side of the robot cleaner station 100, a front end of the dust collection part 140 and/or a front end of the rag washing part 160 may be disposed at left and right sides of the inlet/outlet 127.

In the robot cleaner station 100 according to the embodiment of the present disclosure, all the dust collection part 140, the rag washing part 160, and the drying part 170 are disposed within a predetermined distance range from an outer periphery of the seating part 120.

This provides an effect of shortening a distance between the dust bin 220 of the robot cleaner 200 and the dust collection part 140, thereby minimizing a flow path loss. In addition, it is possible to restrict a range in which the washing water is present and wastewater produced after the washing process is present by minimizing a distance between the rag 242 of the robot cleaner 200 and the rag washing part 160 and a distance between the rag 242 of the robot cleaner 200 and the drying part 170.

In addition, with the above-mentioned arrangement, all the constituent components of the robot cleaner station 100 of the present disclosure may be disposed within a limited height.

As a result, in the robot cleaner station 100 according to the embodiment of the present disclosure, the dust collection part 140, the rag washing part 160, and the drying part 170 may be disposed on the three surfaces that surround the seating part 120, except for the front surface into which the robot cleaner 200 is introduced. With the above-mentioned arrangement, even in a situation in which a height in the vertical direction is restricted, the minimum horizontal space may be used not only to charge the robot cleaner 200, but also to collect dust from the robot cleaner 200, wash the rag 242, and dry the rag 242.

### Seating Part

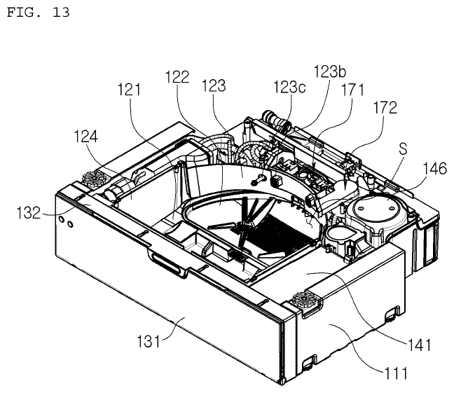

As illustrated in FIGS. 13 to 16, the robot cleaner station 100 may include the seating part 120.

The robot cleaner 200 and the robot cleaner station 100 may be connected through the seating part 120 in a physical, electrical, and/or flow path manner.

The seating part 120 may be disposed in the housing 110.

The inlet/outlet 127 into which the robot cleaner 200 is introduced may be formed at a front side of the seating part 120. The inlet/outlet 127 may refer to a space formed in the front surface of the robot cleaner station 100.

The inlet/outlet 127 may be sized to allow the robot cleaner 200 to pass therethrough. That is, a height of the inlet/outlet 127 is larger than a height of the robot cleaner 200.

At least one of the dust collection part 140 and the rag washing part 160 may be disposed at the left and right sides of the inlet/outlet 127. Therefore, the left and right ends of the inlet/outlet 127 may define a boundary with the dust collection part 140 and the rag washing part 160.

In this case, the inlet/outlet 127 may be opened or closed by the door 131.

The seating part 120 may include an accommodation space S, a base 121, a coupling wall 123, and inner walls 124.

The robot cleaner 200 may be accommodated in the accommodation space S of the seating part 120. For example, the accommodation space S may refer to a space surrounded by the base 121, the coupling wall 123, and the inner walls 124. In another example, the accommodation space S may refer to a space surrounded by the base 121, a washing plate 122, the coupling wall 123, and the inner walls 124.

The base 121 may be configured to support the robot cleaner 200 in case that the robot cleaner 200 is coupled to the robot cleaner station 100. The wheel 260 of the robot cleaner 200 may come into contact with an upper surface of the base 121. In addition, the auxiliary wheel 270 of the robot cleaner 200 may come into contact with the upper surface of the base 121.

The base 121 may include a base main body 121a, an inclined portion 121b, wheel coupling portions 121c, an agitator accommodation portion 121d, and a washing tub 128.

The base main body 121a may define an overall external shape of the base 121. The inclined portion 121b, the wheel coupling portions 121c, the agitator accommodation portion 121d, and the washing tub 128 may be disposed on the base main body 121a.

The base main body 121a may have a shape in which a length and width thereof in the horizontal direction are larger than a height thereof in the upward/downward direction. With this structure, the robot cleaner station 100 may be stably supported on the floor surface.

A return flow path may be provided in the base main body 121a. Therefore, air discharged from the dust collection motor 145 may flow in a return flow path 125a formed in the base main body 121a and be discharged to an air return port 125b.

The inclined portion 121b may be disposed in an inlet of the base main body 121a on which the robot cleaner 200 climbs.

The inclined portion 121b may be inclined upward and forward in the direction in which the robot cleaner 200 enters.

The inclined portion 121b may have wheel guide portions 121ba.

The wheel guide portion 121ba may be provided in the form of a groove to guide the movement of the robot cleaner 200 relative to the wheel 260.

The inclined portion 121b may have an auxiliary wheel guide portion 121bb.

The auxiliary wheel guide portion 121bb may be provided in the form of a groove in order to guide the movement of the robot cleaner 200 relative to the auxiliary wheel 270. In addition, the auxiliary wheel guide portion 121bb may be formed in a protruding shape so that the auxiliary wheel guide portion 121bb adjoins the auxiliary wheel 270 when the wheel 260 of the robot cleaner 200 is seated on the wheel guide portion 121ba. Therefore, when the robot cleaner 200 travels on the inclined portion 121b, the robot cleaner 200 may travel while being stably supported by the auxiliary wheel 270 as well as the wheels 260.

The wheels 260 of the robot cleaner 200 raised along the wheel guide portions 121ba may be seated on the wheel coupling portions 121c. When the wheel 260 of the robot cleaner 200 is seated on the wheel coupling portion 121c, the robot cleaner 200 and the robot cleaner station 100 may be physically coupled.

A shape of the wheel coupling portion 121c may be a shape, i.e., an arcuate shape corresponding to a shape of the wheel 260 of the robot cleaner 200.

At least a part of the agitator 250 of the robot cleaner 200 may be accommodated in the agitator accommodation portion 121d.

The agitator accommodation portion 121d may be formed between the wheel coupling portions 121c. The agitator accommodation portion 121d may be formed in a shape corresponding to the agitator 250 of the robot cleaner 200. The agitator accommodation portion 121d may be formed in a rectangular parallelepiped shape opened at an upper side thereof.

The agitator accommodation portion 121d may be recessed in the base main body 121a. Therefore, the agitator accommodation portion 121d may provide a space that accommodates a lower end of the agitator 250 in the state in which the wheels 260 of the robot cleaner 200 are seated on the wheel coupling portions 121c.

The air return port 125b may be formed in the agitator accommodation portion 121d. The air return port 125b may be formed in a lateral surface of the agitator accommodation portion 121d. The air return port 125b may connect a depressed portion 121da and the dust collection motor 145 through the return flow path. The depressed portion 121da and the return flow path may communicate with each other through the air return port 125b. Therefore, the air discharged from the dust collection motor 145 may pass through the air return port 125b and be discharged to the depressed portion 121da of the agitator accommodation portion 121d.

The agitator accommodation portion 121d may guide air, which is discharged through the air return port 125b, to the suction part 211 of the robot cleaner 200.

Meanwhile, a drawer 190 may be provided on the base 121 and configured to be withdrawable from the housing 110. In this case, the base 121 may be withdrawn while passing through the inlet/outlet 127 along a space between the inner walls 124.

In order to facilitate the withdrawal, the base 121 may be formed with a base handle 121e. The base handle 121e may be formed between the agitator accommodation portion 121d and the auxiliary wheel guide portion 121bb. In addition, the base handle 121e may be formed between the pair of wheel guide portions 121ba.

With this configuration, the user may easily withdraw the base 121 by holding and pulling the handle 121e.

The coupling wall 123 is a component in which a dust passage hole 123a, the electric power supply terminal 123b, and a water supply nozzle 123c of the robot cleaner station 100 are disposed. The coupling wall 123 may spatially distinguish the accommodation space S from components of the robot cleaner station 100. The coupling wall 123 may extend in the vertical direction from a rear side of the base 121. The coupling wall 123 may be formed to correspond to a shape of the robot cleaner 200. For example, in case that the body 210 of the robot cleaner 200 has a cylindrical shape, the coupling wall 123 may be formed in a circular arc shape having a predetermined radius. With this configuration, it is possible to increase an area that may surround an outer periphery of the robot cleaner 200 and face the outer surface of the robot cleaner 200. In addition, the robot cleaner 200 may be stably supported.

The seating part 120 may be formed with the dust passage hole 123a through which air existing outside the housing 110 may be introduced into the housing 110. Specifically, the dust passage hole 123a may be formed in the coupling wall 123 so that outside air may be introduced into the housing 110.

The dust passage hole 123a may communicate with the dust bin 220 of the robot cleaner 200.

The electric power supply terminal 123b may supply electric power to the robot cleaner 200 coupled to the seating part 120. The electric power supply terminal 123b may come into contact with and be electrically connected to the charging terminal of the robot cleaner 200. The electric power supply terminal 123b may be disposed on the seating part 120. Specifically, the electric power supply terminal 123b may be disposed on the coupling wall 123. The electric power supply terminal 123b may be electrically connected to the robot cleaner 200 coupled to the coupling wall 123. The electric power supply terminal 123b may supply electric power to the battery of the robot cleaner 200 coupled to the coupling wall 123.

The robot cleaner station 100 may further include the water supply nozzle 123c.

The water supply nozzle 123c may be connected to the supply part 231 of the water container 230 of the robot cleaner 200. Specifically, the water supply nozzle 123c may be connected to the injection port of the water container 230. The water supply nozzle 123c may supply water, which is supplied from the water supply pipe of the kitchen cabinet 2, to a storage space in the water container 230 of the robot cleaner 200.

The inner walls 124 is configured to spatially distinguish the accommodation space S of the seating part 120 from the components of the robot cleaner station 100. The inner walls 124 may be provided as a pair of inner walls 124 disposed at the left and right sides of the base 121. The inner walls 124 may be connected to two opposite ends of the coupling wall 123. The inner walls 124 may extend from the left and right sides of the base 121 in a direction intersecting the base 121. Specifically, the inner wall 124 may extend from the left and right sides of the base 121 in the vertical direction.

Meanwhile, various types of components, such as dust collection flow paths 147 and 148, the dust collection part 140, the dust collection motor 145, a detergent container 163, and a wastewater container 166 may be disposed outside the inner wall 124. Specifically, the dust collection part 140, the detergent container 163, and the wastewater container 166 may be disposed in a space between the inner wall 124 and the outer wall 111 of the housing 110.

The dust collection part 140 and the detergent container 163 may be separated in a sliding manner from the space between the inner wall 124 and the outer wall 111 of the housing 110. Widths of the dust collection part 140 and the detergent container 163 in the leftward/rightward direction may be smaller than a distance between the inner wall 124 and the outer wall 111 of the housing 110.

The washing plate 122 may be configured to wash the rag of the robot cleaner 200, and the washing plate 122 may be seated in the washing tub 128 of the base 121. In addition, the washing plate 122 may come into contact with the rag 242 in the state in which the robot cleaner 200 is seated.

The washing plate 122 may be a plate inclined downward toward a central portion thereof as a whole.

Specifically, the washing plate 122 includes a flow guide surface 122c formed as a curved surface. Further, one or more passing holes 122b through which the fluid may pass may be formed in the flow guide surface 122c. In addition, washing protrusions 122a may protrude from the flow guide surface 122c.

In this case, the washing protrusions 122a may be provided as a pair of washing protrusions 122a symmetrically formed on the flow guide surface 122c.

Further, the passing holes 122b may be provided as a plurality of passing holes 122b formed in the flow guide surface 122c and formed between the pair of washing protrusions 122a.

Meanwhile, a height of the flow guide surface 122c from the floor of the kitchen may increase rearward from the position at which the passing holes 122b are formed. That is, the height of the flow guide surface 122c from the floor of the kitchen may increase as the distance from an outside air discharge part 171c to be described below decreases.

With this configuration, the washing water and/or air may flow along the flow guide surface 122c and enter a space formed between the washing plate 122 and the washing tub 128 through the passing holes 122b.

When the washing water is supplied to the washing plate 122 and the rags 242 rotates, the rags 242 may be washed by friction with the washing protrusions 122a provided in a stationary state.

Meanwhile, at least a part of the washing plate 122 may be disposed above a flow path forming portion 128c to be described below. That is, the washing plate 122 may further include a return flow path cover portion 122d protruding upward from the flow guide surface 122c and coupled to an upper side of the flow path forming portion 128c.

The washing plate 122 of the present embodiment may be formed in a shape corresponding to a shape of the flow path forming portion 128c. For example, a front left portion of the washing plate 122 may protrude upward from the flow guide surface 122c and cover the flow path forming portion 128c disposed therebelow.

With this configuration, the washing plate 122 and the washing tub 128 may be accurately coupled while simultaneously providing a sufficient space in which the return flow path 125a may be formed.

The washing tub 128 is a component in which the washing plate 122 is seated. The washing tub 128 may be disposed rearward of the base main body 121a. The washing tub 128 may be disposed below the washing plate 122 and detachably coupled to the washing plate 122. The washing tub 128 may be formed to correspond to the washing plate 122 so as to be fitted with the washing plate 122. The liquid passing through the washing plate 122 may be introduced into the washing tub 128.

The washing tub 128 may include a washing tub base surface 128a along which the fluid having passed through the washing plate 122 flows, and a washing tub wall 128b extending and protruding in the vertical direction from an outer periphery of the washing tub base surface 128a. In this case, a height of the washing tub base surface 128a from the ground surface (the floor of the kitchen) may decrease toward the rear side of the robot cleaner station 100. Therefore, the fluid having passed through the washing plate 122 may be collected at a rear side of the washing tub 128 and discharged to the outside through a wastewater inlet port 164c to be described below.

In this case, a wastewater pipe connection port 128d may be formed in the washing tub wall 128b so as to be coupled to the wastewater inlet port 164c.

Meanwhile, the washing tub 128 may be formed with the flow path forming portion 128c. The flow path forming portion 128c may protrude upward from the washing tub base surface 128a and form the return flow path 125a therebelow.

Meanwhile, the washing tub 128 according to the present disclosure may be configured to be withdrawable from the rag washing part 160. That is, the washing tub 128, together with the base 121, may be withdrawn from the housing 110. In addition, the washing plate 122 may be withdrawn from the rag washing part 160.

### Door Part

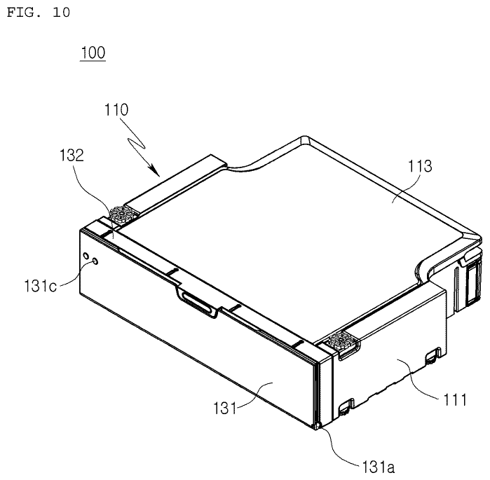

FIGS. 10 to 12 are views for explaining the door part 130.

The door part 130 may be provided to cover an entire front end of the housing 110. The door 131 may cover a dust bag drawer 144 and the detergent container 163 so that the dust bag drawer 144 and the detergent container 163 are not exposed to the outside.

The door 131 may form a front external appearance of the robot cleaner station 100 in a state in which the inlet/outlet 127 is closed. For example, the door 131 may be formed in a shape similar to a rectangular flat plate-like shape.

A door frame 132 may be disposed at a front side of the housing 110. The door 131 may be openably and closably coupled to the door frame 132. In addition, the door frame 132 may be formed with a dust bag withdrawal port 132a to which the dust bag drawer 144 and the inlet/outlet 127, through which the robot cleaner 200 may enter or exit, are coupled to be withdrawable, and a detergent container insertion port 132b to which the detergent container 163 is coupled to be withdrawable.

A rotary shaft 131a of the door 131 may be disposed at a lower end of the door frame 132. When the inlet/outlet 127 is open, the door 131 may be disposed in parallel with the floor surface or inclined downward and forward, such that an end thereof may come into contact with the ground surface.

The door 131 may be provided with a hinge part and be rotatably connected to the door frame 132. The hinge part may be provided as a plurality of hinge parts disposed along the rotary shaft 131a and spaced apart from one another at different intervals.

In addition, auxiliary entry paths 131b may be provided on a surface of the door 131 that faces the housing 110 when the inlet/outlet 127 is closed.

Specifically, the auxiliary entry paths 131b may be formed in the shape of grooves to allow the robot cleaner 200 to stably travel inclinedly. Therefore, the wheel 260 of the robot cleaner 200 may be guided to the exact position while the leftward and rightward movements of the wheel 260 are restricted as the wheel 260 travels toward the seating part 120 or the inlet/outlet 127.

The auxiliary entry paths 131b guide the wheel 260 to the wheel guide portions 121ba disposed on the seating part 120. The auxiliary entry paths 131b may be provided as a pair of auxiliary entry paths 131b respectively disposed at positions connected to the pair of wheel guide portions 121ba.

An entry sensor 135 may be installed on the door frame 132 and recognize the approach of the robot cleaner 200. The entry sensor 135 may be disposed at the front side of the housing 110 to recognize the approach of the robot cleaner 200. For example, the entry sensor 135 may be an IR sensor.

The entry sensor 135 may be installed at an upper side of a front surface of the door frame 132. Therefore, it is possible to maximize a detection range. In addition, the entry sensor 135 may be installed at a central portion of the inlet/outlet 127 based on the leftward/rightward direction. Therefore, an entry direction of the robot cleaner 200 may be guided in accordance with communication with the robot cleaner 200.

Meanwhile, the door 131 may be formed in a shape in which a portion facing the entry sensor 135 is cut out so that the entry sensor 135 may detect a front location even in the state in which the door 131 closes the inlet/outlet 127. Alternatively, the door 131 may be provided with a transparent window provided at a position that faces the entry sensor 135.

A door manipulation part 133 may be installed on the door frame 132, and the user may rotate the door 131 by manipulating the door manipulation part 133.

The door manipulation part 133 may be provided with at least one button disposed on the door frame 132 and configured to operate the door 131. The door manipulation part 133 may rotate the door 131 regardless of a position or state of the robot cleaner 200.

The door manipulation part 133 may be disposed in the door frame 132. Further, at least one button of the door manipulation part 133 may be disposed to be exposed to the outside.

In this case, the button may be disposed adjacent to the detergent container 163 based on the inlet/outlet. For example, the button may be disposed above a handle 163b of the detergent container 163.

Meanwhile, when the door 131 closes the inlet/outlet 127, the door 131 also covers the door manipulation part 133. In this case, external button parts 131c are provided on the door 131 so that the door manipulation part 133 may be manipulated even in the state in which the inlet/outlet 127 is closed. The external button parts 131c are configured to be equal in number to the buttons of the door manipulation part 133 and provided at positions facing the buttons. The external button part 131c may be made of an elastically deformable material and configured to press the button when an external force is applied.

The door 131 may be rotated by a door driving part 134. For example, the door driving part 134 may include a door drive motor and a driving gear part.

The door drive motor may be disposed in the housing 110 and disposed in an upper space of the detergent container 163.

The driving gear part is configured to connect the door drive motor and the door 131 and transmit power. The driving gear part rotates the door 131 by transmitting driving power from the door drive motor to the door 131.

### Dust Collection Part

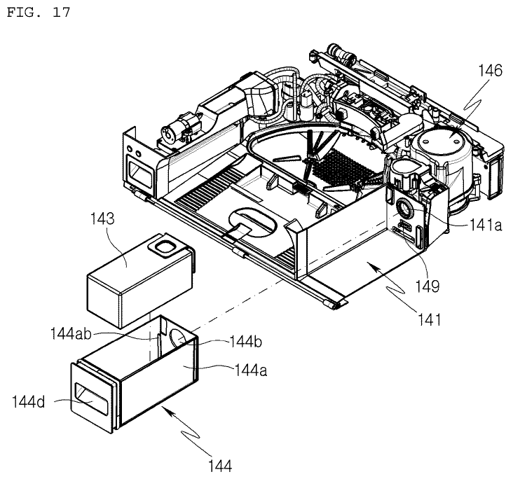

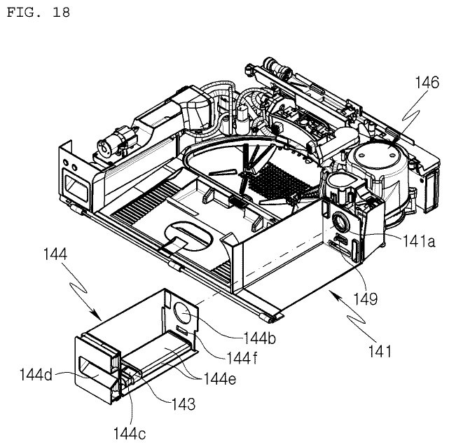

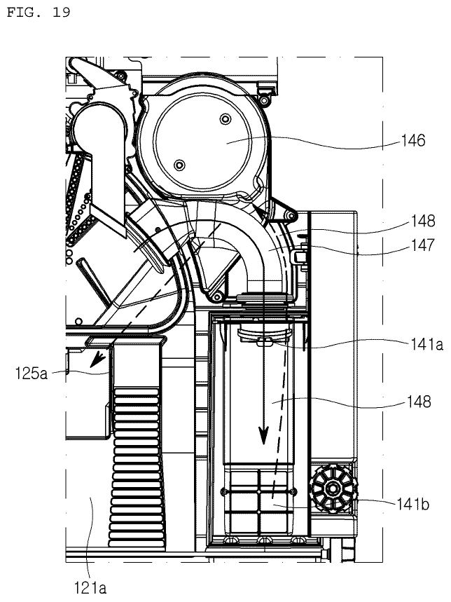

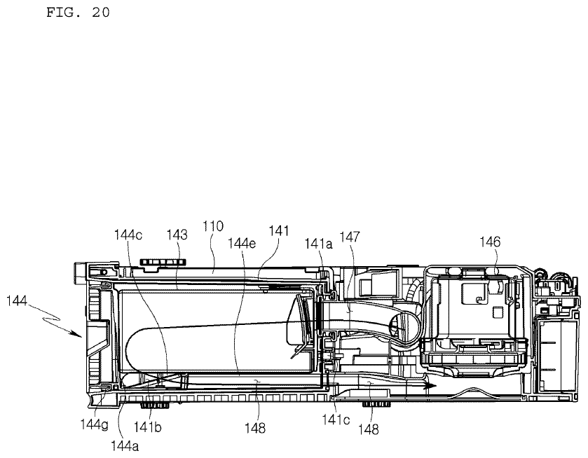

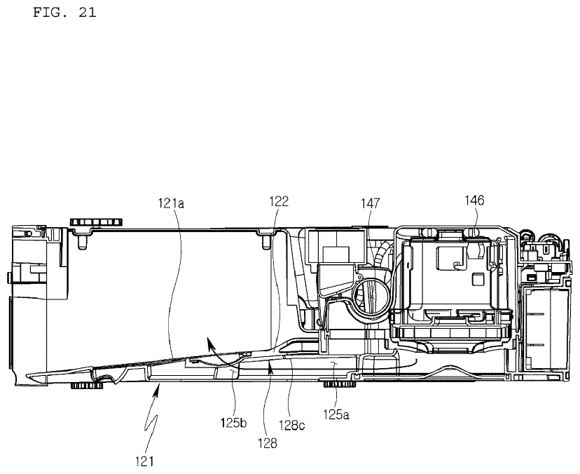

FIGS. 13 to 21 are views for explaining the dust collection part of the robot cleaner station according to the embodiment of the present disclosure.

The dust collection part 140 will be described below with reference to FIGS. 13 to 21.

The dust collection part 140 may collect dust from the dust bin 220 of the robot cleaner 200. The dust collection part 140 may be disposed in the housing 110. The dust collection part 140 may be disposed outside the seating part 120. For example, the dust collection part 140 may be disposed at one side of the seating part 120 based on leftward/rightward direction.

The dust collection part 140 may include a dust collection part housing 141, a filter 142, a dust bag 143, the dust bag drawer 144, the dust collection motor 145, a dust collection motor housing 146, a first dust collection flow path 147, and a second dust collection flow path 148.

The dust collection part housing 141 may form a space in which the filter 142, the dust bag 143, and the dust bag drawer 144 may be accommodated.

The dust bag drawer 144, which may be withdrawn, may be coupled in the dust collection part housing 141, and the dust bag 143 may be accommodated in the dust bag drawer 144.

Dust in the dust bin 220 may be introduced into the dust collection part housing 141.

One side of the inside of the dust collection part housing 141 may communicate with the first dust collection flow path 147, and the other side of the inside of the dust collection part housing 141 may communicate with the second dust collection flow path 148. In addition, when the dust bag 143 is coupled to the dust collection part housing 141, the dust bag 143 may be disposed in the dust collection part housing 141 and communicate with the first dust collection flow path 147.

Specifically, the dust collection part housing 141 may be formed with an inlet port 141a configured to communicate with the first dust collection flow path 147, and an outlet port 141b configured to communicate with the second dust collection flow path 148.

In this case, the inlet port 141a may be disposed above the outlet port 141b. Therefore, the air and dust introduced through the inlet port 141a may flow downward, and the dust may be trapped in the dust bag 143 and then discharged through the outlet port 141b.

Meanwhile, in the present embodiment, the outlet port 141b may be disposed forward of the inlet port 141a.

Meanwhile, the outlet port 141b may be formed by coupling the dust collection part housing 141 and the dust bag drawer 144. In this case, the outlet port 141b of the dust collection part housing 141 and an outlet port 144c of the dust bag drawer 144 may refer to the same space.

The dust bag drawer 144 includes a dust bag drawer body 144a, an inlet port 144b, the outlet port 144c, a handle 144d, and a flow path forming portion 144e.

The dust bag drawer body 144a may provide a space in which the dust bag 143 may be coupled. For example, the dust bag drawer body 144a may be formed in the shape of a box opened at an upper side thereof, and the inlet port 144b may be formed in a rear surface of the dust bag drawer body 144a so as to communicate with the first dust collection flow path 147. In this case, the inlet port 144b may communicate with the inlet port 141a of the dust collection part housing 141.

An upper side of the dust bag drawer body 144a may communicate with the first dust collection flow path 147 through the inlet port 144b. The inlet port 144b may be configured to guide air, which flows through the first dust collection flow path 147, into the dust bag 143. The inlet port 144b may allow the first dust collection flow path 147 and the dust bag 143 to communicate with each other. Therefore, dust sucked from the dust bin 220 of the robot cleaner 200 may move into the dust bag 143 via the first dust collection flow path 147, the inlet port 141a of the dust collection part housing 141, and the inlet port 144b of the dust bag drawer 144.

The dust bag drawer 144 may communicate with the second dust collection flow path 148 through the outlet port 144c formed in a lower surface (bottom surface) thereof.

In this case, the outlet port 144c and the inlet port 144b may be disposed at different heights. The outlet port 144c may be disposed to be lower than the inlet port 144b based on the lower surface (bottom surface) of the dust bag drawer 144. The outlet port 144c may allow an internal space of the dust bag drawer 144 and the second dust collection flow path 148 to communicate with each other. Therefore, the air, from which dust is filtered out while the air passes through the dust bag 143, may move to the second dust collection flow path 148 via the outlet port 144c.

Meanwhile, in the present embodiment, the outlet port 144c may be disposed forward of the inlet port 144b. For example, the outlet port 144c may be disposed to be closer to the handle 144d than the inlet port 144b to the handle 144d.

Meanwhile, the dust bag drawer 144 forms a flow path through which the air having passed through the dust bag 143 is discharged to the dust collection motor 145. That is, the dust bag drawer 144 includes the flow path forming portion 144e protruding upward from a bottom surface of the dust bag drawer body 144a and configured to form a flow path between the flow path forming portion 144e and the dust collection part housing 141.

The flow path forming portion 144e may be provided on a lower surface of the dust bag drawer body 144a and form at least a part of the second dust collection flow path 148.

Therefore, at least a part of the second dust collection flow path 148 may be formed by coupling the flow path forming portion 144e and a bottom surface of the dust collection part housing 141.

Meanwhile, the flow path forming portion 144e may be formed in a longitudinal direction of the dust bag drawer 144. In this case, the outlet port 144c may be formed at one end of the flow path forming portion 144e based on the longitudinal direction.

Therefore, the air introduced into the outlet port 144c may flow rearward in the longitudinal direction of the flow path forming portion and be discharged to the dust collection motor 145.

Meanwhile, the remaining part of the second dust collection flow path 148 may be a space formed by coupling a dust collection motor support portion 146c and a lower dust collection motor housing 146b that will be described below.

Therefore, in the present embodiment, the first dust collection flow path 147 and the second dust collection flow path 148 may be formed at different heights. That is, the first dust collection flow path 147 and the second dust collection flow path 148 may be disposed as layered structures. In this case, at least a part of the first dust collection flow path 147 may be disposed above the second dust collection flow path 148.

In addition, the first dust collection flow path 147 and the second dust collection flow path 148 may be formed in different surfaces of the dust collection part housing 141. For example, the first dust collection flow path 147 may be formed in a rear surface of the dust collection part housing 141, and the second dust collection flow path 148 may be formed along a lower surface of the dust collection part housing 141.

Meanwhile, the handle 144d may be provided forward of the dust bag drawer body 144a. The handle 144d may be configured to be gripped by the user.

Therefore, according to the present disclosure, the user may easily pull the dust bag drawer 144 forward, raise the dust bag 143 upward, and then remove and replace the dust bag 143.

The filter 142 may be disposed in the dust bag drawer 144. Specifically, the filter 142 may be disposed in the dust bag drawer 144 and withdrawn together with the dust bag drawer 144.

Meanwhile, the filter 142 may be disposed to be lower than the inlet port 144b based on the bottom surface of the dust bag drawer body 144a. The filter 142 may be disposed forward of the outlet port 144c of the dust bag drawer 144.

Specifically, the filter 142 may be detachably coupled to the lower surface of the dust bag drawer 144. In this case, the filter 142 may be disposed at one end (front end) of the flow path forming portion 144e based on the longitudinal direction. Therefore, the filter 142 may be disposed between the handle 144d and the flow path forming portion 144e.

When the dust bag drawer 144 is withdrawn, the filter 142 may be withdrawn together with the dust bag drawer 144.

The filter 142 may be disposed below the dust bag 143. In this case, the dust bag 143 may be coupled to be detachable from the dust bag drawer 144 in the vertical direction in a sliding manner.

The dust bag 143 may refer to a dust collection bag configured to collect dust sucked from the interior of the dust bin 220 of the robot cleaner 200 by the dust collection motor 145.

The dust bag 143 may be detachably coupled to the dust bag drawer 144. Therefore, the dust bag 143 may be separated from the dust bag drawer 144 and discarded, and a new dust bag 143 may be coupled to the dust bag drawer 144. That is, the dust bag 143 may be defined as a consumable component.

An inlet port of the dust bag 143 may be disposed to communicate with the inlet port 144b of the dust bag drawer 144. Therefore, when the dust collection motor 145 operates, air and dust in the dust bin 220 may be introduced into the dust bag 143 and captured.

When a suction force is generated by the dust collection motor 145, a volume of the dust bag 143 is increased, such that the dust may be accommodated in the dust bag 143. To this end, the dust bag 143 may be made of a material that transmits air but does not transmit debris such as dust. For example, the dust bag 143 may be made of a non-woven fabric material and have a hexahedral shape corresponding to a shape of the dust bag drawer 144 when the bag 143 has an increased volume.

The dust collection part 140 may further include a dust collection module. The dust collection module may provide a suction gas flow to the dust collection flow path.

Specifically, the dust collection part 140 may further include the dust collection motor 145 and the dust collection motor housing 146.

The dust collection motor 145 may generate a suction force in the dust collection flow paths 147 and 148. That is, the dust collection motor 145 may provide a suction force that sucks the dust in the dust bin 220 into the dust bag 143 disposed in the dust collection part housing 141.

The dust collection motor 145 may be disposed rearward of the dust collection part housing 141. Therefore, the dust collection motor 145 may provide a suction force capable of sucking dust in the dust bin 220 of the robot cleaner 200.

The dust collection motor 145 may generate the suction force by means of the rotation. For example, although not illustrated, the dust collection motor 145 may include a rotor and a stator that perform a relative rotation by receiving electric power, and the dust collection motor 145 may include an impeller configured to be rotated about a rotary shaft by the rotation of the rotor. Therefore, the suction force may be generated by the rotation of the impeller.

One side of the dust collection motor 145 may be connected to the second dust collection flow path 148, and the other side of the dust collection motor 145 may be connected to the return flow path 125a. In case that the dust collection motor 145 operates, the air flowing through the second dust collection flow path 148 may be introduced into the dust collection motor housing 146. In addition, the air introduced into the dust collection motor housing 146 may pass through the dust collection motor 145 and then flow through the return flow path 125a.

Meanwhile, in the present embodiment, a rotary shaft of the dust collection motor 145 may be disposed in the vertical direction. In this case, it is possible to minimize a horizontal space occupied by the dust collection motor 145.

Meanwhile, in case that the rotary shaft of the dust collection motor 145 is disposed in the vertical direction, a side at which the air is introduced into the dust collection motor 145 and a side at which the air is discharged from the dust collection motor 145 may be disposed at different heights. Therefore, a structure of the dust collection motor housing 146 may be formed.

The dust collection motor 145 may be accommodated in the dust collection motor housing 146. The dust collection motor housing 146 may be disposed rearward of the dust collection part housing 141.

In the present embodiment, the dust collection motor housing 146 includes an upper dust collection motor housing 146a, the lower dust collection motor housing 146b, the dust collection motor support portion 146c, and a motor damper 146d.

In this case, the dust collection motor 145 may be seated on the dust collection motor support portion 146c, the upper dust collection motor housing 146a may be coupled to an upper side of the dust collection motor support portion 146c, and the lower dust collection motor housing 146b may be disposed below the dust collection motor 145. Meanwhile, the motor damper 146d may be coupled between the dust collection motor support portion 146c and the upper dust collection motor housing 146a.

With this arrangement, after the motor damper 146d is coupled in the state in which the dust collection motor 145 is seated on the dust collection motor support portion 146c, the upper dust collection motor housing 146a may be assembled, and the lower dust collection motor housing 146b may be assembled to a lower surface of the housing 110.

The upper dust collection motor housing 146a may cover an upper side of the dust collection motor 145. The upper dust collection motor housing 146a may include a motor accommodation portion configured to accommodate a part of the upper side of the dust collection motor 145, and an upper flow path forming portion connected to the motor accommodation portion and having a flow path formed therein.

The motor accommodation portion may be formed in a shape similar to a cylindrical shape closed at an upper end thereof. The air discharged from the dust collection motor 145 may flow to a space between the motor accommodation portion and the dust collection motor 145 and be discharged to the upper flow path forming portion.

The upper flow path forming portion may extend radially outward from an outer peripheral surface of the motor accommodation portion. Therefore, it is possible to guide a flow direction of the air discharged from a portion between the motor accommodation portion and the dust collection motor 145. In addition, an upper surface of the upper flow path forming portion may be formed with a groove to accommodate at least a part of a pipe or hose that forms the first dust collection flow path 147.

With this configuration, at least a part of the first dust collection flow path 147 may pass through an upper side of the upper flow path forming portion.

The upper flow path forming portion may form therein at least a part of the return flow path 125a. Specifically, the space formed by coupling the upper flow path forming portion and the dust collection motor support portion 146c may form a part of the return flow path 125a.

The lower dust collection motor housing 146b may cover a lower side of the dust collection motor 145. The lower dust collection motor housing 146b may be coupled to a lower surface of the drawer 190.

The dust collection motor support portion 146c may support the dust collection motor 145.

The dust collection motor support portion 146c may be connected to various components that form the internal structure of the robot cleaner station 100. The dust collection motor support portion 146c may be connected to the dust collection part housing 141. The dust collection motor support portion 146c may be connected to the inner wall 124 or the coupling wall 123 of the seating part 120. Therefore, the dust collection motor support portion 146c may provide a supporting force for supporting the dust collection motor 145.

The dust collection motor support portion 146c may be coupled to the upper dust collection motor housing 146a and the lower dust collection motor housing 146b and form the return flow path 125a and the second dust collection flow path 148. Therefore, the plurality of flow paths may be disposed to be stacked on one another, thereby maximizing spatial efficiency within a limited height range.

Therefore, according to the present disclosure, the dust collection motor 145 may be disposed in the vertical direction, and two flow paths, which are separated in the upward/downward direction, may be formed by the dust collection motor support portion 146c.

Meanwhile, the motor damper 146d may be coupled between the dust collection motor support portion 146c and the dust collection motor 145 and elastically support the dust collection motor 145.

Meanwhile, the motor damper 146d may be made of a material having elasticity.

Therefore, according to the present disclosure, because the dust collection motor 145 is disposed in the vertical direction, a damper 146d may be provided below the dust collection motor 145, thereby reducing vibration and noise occurring due to the operation of the dust collection motor 145.

Meanwhile, the dust collection part 140 may further include the dust collection flow paths 147 and 148. The dust collection flow path may refer to a flow path through which the air sucked through the dust passage hole 123a flows to the dust collection motor 145 via the dust bag.

Specifically, the dust collection flow path may include the first dust collection flow path 147 configured to allow the dust bin 220 and an internal space of the dust collection part housing 141 to communicate with each other when the robot cleaner 200 is coupled to the robot cleaner station 100 and the dust passage hole 123a and the dust bin 220 of the robot cleaner 200 communicate with each other, and the second dust collection flow path 148 configured to allow the internal space of the dust collection part housing 141 and an internal space of the dust collection motor housing 146 to communicate with each other.

The first dust collection flow path 147 may connect the dust bin 220 of the robot cleaner 200 and the internal space of the dust collection part housing 141. The first dust collection flow path 147 may connect the dust passage hole 123a of the seating part 120 and the internal space of the dust collection part housing 141. The first dust collection flow path 147 may be formed in a direction intersecting the vertical direction. For example, the first dust collection flow path 147 may be formed to be close to the horizontal direction. The first dust collection flow path 147 may be a space formed rearward of the dust passage hole 123a. The first dust collection flow path 147 may be a flow path bent laterally from the dust passage hole 123a, and the dust and the air may flow through the first dust collection flow path 147. The dust in the dust bin 220 of the robot cleaner 200 may move to the internal space of the dust collection part housing 141 through the first dust collection flow path 147.

The second dust collection flow path 148 may connect the internal space of the dust collection part housing 141 and the internal space of the dust collection motor housing 146. The second dust collection flow path 148 may be formed in a direction intersecting the vertical direction. For example, the second dust collection flow path 148 may be formed to be close to the horizontal direction.

In this case, in the present disclosure, the first dust collection flow path 147 and the second dust collection flow path 148 may be formed at different heights. That is, the first dust collection flow path 147 and the second dust collection flow path 148 may be disposed as layered structures. At least a part of the first dust collection flow path 147 may be disposed above the second dust collection flow path 148.

With this configuration, the plurality of flow paths may be disposed to be close to the horizontal direction, thereby reducing an overall height, and simultaneously, the plurality of flow paths may be stacked, thereby minimizing an overall volume and width of the robot the cleaner station 100 in the leftward/rightward direction.

An air return part 125 may guide the air, which is discharged from the dust collection motor 145, to the robot cleaner 200.

The air return part 125 may include the return flow path 125a and the air return port 125b.

The return flow path 125a may provide a flow path in which the air discharged from the dust collection motor 145 flows. The return flow path 125a may be formed by the dust collection motor housing 146 and the base 121. Specifically, one side of the return flow path 125a may be a space formed by coupling the dust collection motor support portion 146c and the upper dust collection motor housing 146a. In addition, the other side of the return flow path 125a may be disposed in the base main body 121a. For example, the return flow path 125a may be a space formed between upper and lower surfaces of the base main body 121a.

Therefore, one side of the return flow path 125a may pass through the dust collection motor housing 146. In addition, the other side of the return flow path 125a may pass through a lower side of the base 121. In addition, at least a part of the return flow path 125a may be disposed below the robot cleaner 200 seated on an upper side of the base main body 121a.

The return flow path 125a may be connected to the dust collection motor 145 in a flow path manner. One end of the return flow path 125a may communicate with the internal space of the dust collection motor housing 146, and the other end of the return flow path 125a may communicate with the air return port 125b.

In this case, at least a part of the return flow path 125a may be disposed below the first dust collection flow path 147. Therefore, a flow direction of the air flowing through the first dust collection flow path 147 and a flow direction of the air flowing through the return flow path 125a may intersect each other on a horizontal plane.

In addition, at least a part of the return flow path 125a may be disposed above the second dust collection flow path 148. That is, the return flow path 125a may be disposed to pass through an upper side of the second dust collection flow path 148.

Therefore, the first dust collection flow path 147, the second dust collection flow path 148, and the return flow path 125a may be disposed (stacked) in the upward/downward direction within a limited height range, thereby maximizing spatial efficiency.

The air return port 125b may be formed in the base 121. The air return port 125b may be formed in the agitator accommodation portion 121d. In this case, the suction part 211 of the robot cleaner 200 may be disposed above the agitator accommodation portion 121d. Therefore, the return flow path 125a may discharge air to a lower side of the suction part 211, and the air having passed through the return flow path 125a may be introduced into the suction part 211 disposed immediately above the return flow path 125a.

Therefore, the return flow path 125a according to the embodiment of the present disclosure may guide the air, which is discharged from the dust collection motor 145, to the suction part 211 of the robot cleaner 200.

The return flow path 125a guides the air, which is discharged from the dust collection motor 145, to the suction part 211 of the robot cleaner 200 without discharging the air to the outside, thereby implementing a structure in which the air continuously circulates between the robot cleaner 200 and the robot cleaner station 100. Therefore, hot air discharged from the dust collection motor 145 may be introduced back into the robot cleaner 200 and circulate without being discharged to the kitchen cabinet 2, thereby preventing damage to the interior of the kitchen cabinet 2.

### Rag Washing Part

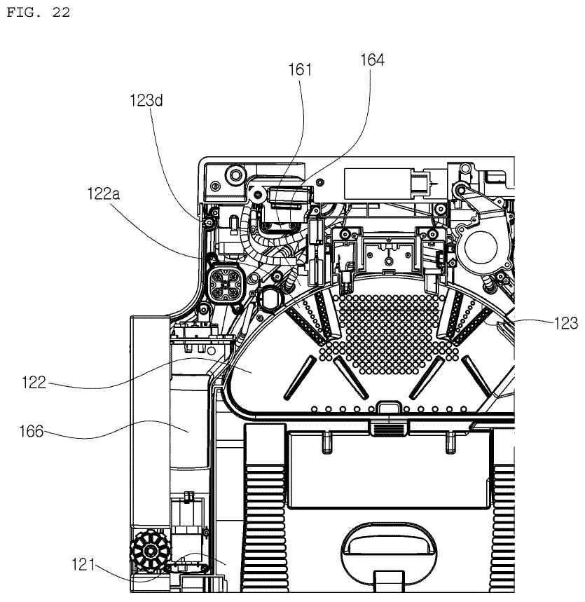

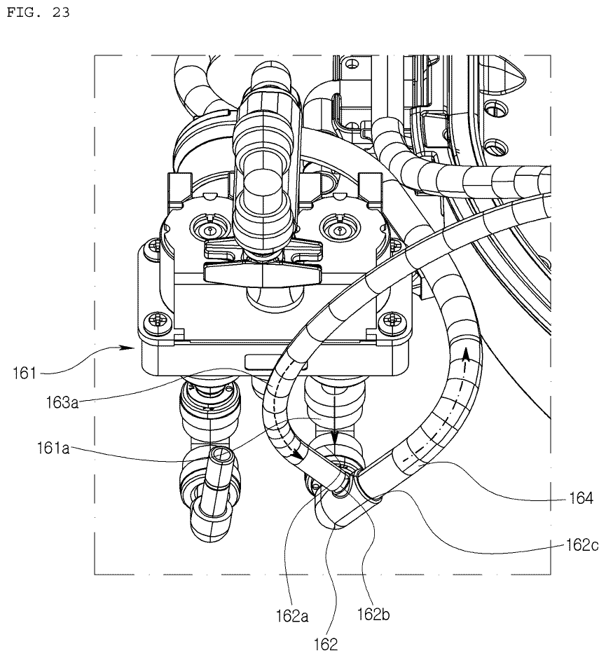

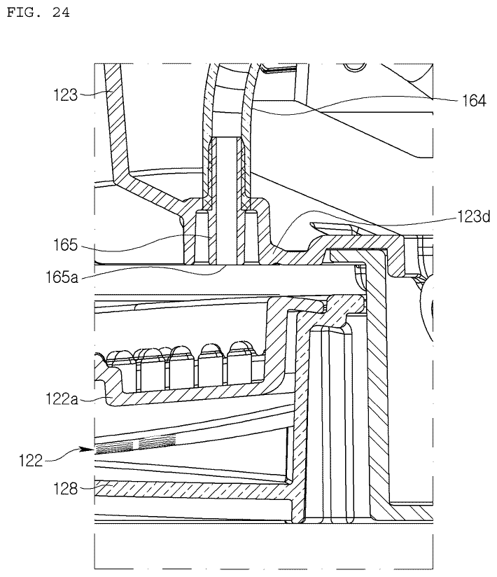

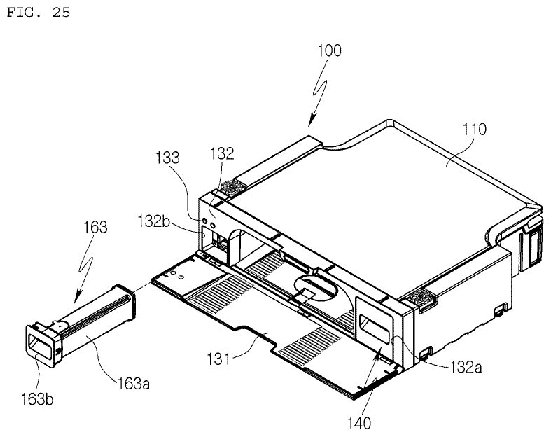

The rag washing part 160 of the robot cleaner station 100 according to the embodiment of the present disclosure will be described below with reference to FIGS. 22 to 25.

The robot cleaner station 100 according to the embodiment of the present disclosure may include the rag washing part 160. The rag washing part 160 may supply the washing water to the rag 242 of the robot cleaner 200 coupled to the seating part 120, wash the rag 242, and drain the wastewater produced after the rag 242 is washed.

The rag washing part 160 may include a washing water supply part configured to mix purified water with a liquid containing a detergent and discharge the mixture to an upper side of the washing plate 122. The washing water supply part may include a regulator 161, a mixing chamber 162, the detergent container 163, a branch flow path 164, and washing water nozzles 165.

In this case, the detergent container 163 and the wastewater container 166 may be accommodated in a space formed between the inner wall 124 and the outer wall 111 of the housing. The detergent container 163 may be disposed at a lower side of the space formed between the inner wall 124 and the outer wall 111 of the housing, and the wastewater container 166 may be disposed above the detergent container 163.

The water supply pipe of the kitchen cabinet 2 may be connected to the regulator 161 and adjust a flow rate of the water supplied from the water supply pipe. In addition, a part of the purified water having passed through the regulator 161 may be supplied to the water container 230 of the robot cleaner 200 through the water supply nozzle 123c, and the remaining purified water may be supplied to the mixing chamber 162.

In addition, the liquid containing the detergent stored in the detergent container 163 may be supplied to the mixing chamber 162 by a flow force of a pump. A detailed structure of the detergent container 163 will be described below.

The mixing chamber 162 is provided with a space in which the detergent-containing liquid and the purified water may be introduced and mixed, and the mixing chamber 162 may discharge the washing water in which the detergent and the purified water are mixed. The mixing chamber 162 may be provided with a purified water inlet port 162a, a detergent inlet port 162b, and a branch flow path connection port 162c.

The mixing chamber 162 may be provided in the housing 110 disposed rearward of the seating part 120. In this case, a flow path 161a, into which the purified water introduced from the regulator 161, may be connected to the purified water inlet port 162a. In addition, a flow path 163a, into which the detergent-containing liquid is introduced from the detergent container 163, may be connected to the detergent inlet port 162b. Therefore, the regulator 161 and the pump of the detergent container 163 may operate for a predetermined period of time and allow a preset amount of purified water and detergent to the mixing chamber 162.

Meanwhile, the branch flow path connection port 162c may be connected to the branch flow path 164. The branch flow path 164 may supply the purified water and the detergent-containing washing water to the pair of washing water nozzles 165.

The branch flow path 164 may be provided in a shape having two tube portions diverged from a single tube portion. In this case, an end of one diverged tube portion may be connected to any one of the pair of washing water nozzles 165, and an end of the other diverged tube portion may be connected to the remaining one of the pair of washing water nozzles 165.

The pair of washing water nozzle 165 may be disposed to be spaced apart from each other. In this case, the pair of washing water nozzles 165 may be disposed at positions that are symmetric to each other.

Further, the branch flow path 164 may be connected to the washing water nozzle 165, the washing water may be introduced into the washing water nozzle 165, and the washing water may be discharged to the washing plate 122. The washing water nozzle 165 may discharge the washing water to an upper surface of the washing plate 122 through a washing water discharge port 165a. The washing water discharge port 165a may be opened in a direction in which the washing water discharge port 165a faces an upper surface of the rag 242 seated on the washing plate 122.

The washing water nozzle 165 may be provided on a nozzle installation wall 123d connected to the coupling wall 123. The washing water nozzle 165 may be positioned at a position higher than an uppermost end of the washing plate 122 so that the washing plate 122 may be detached.

Further, the washing water nozzles 165 may be disposed at positions spaced apart vertically upward from positions spaced apart from centers of the washing protrusions 122a based on a width direction. The washing water discharge port 165a may be disposed between a protrusion 122aa and a washing rib 122ab and disposed to be spaced apart from the protrusion 122aa in a direction opposite to the rotation direction of the rag 242.

The detergent container 163 includes a detergent container body 163a, the handle 163b, and detergent container rails.

The detergent container body 163a may provide a space that may store the liquid containing the detergent. For example, the detergent container body 163a may be formed in the shape of a box opened at an upper side thereof.

The handle 163b may be provided forward of the detergent container body 163a. The handle 163b may be configured to be gripped by the user.

With this configuration, when the user grips the handle 163b and pulls the handle 163b forward, the detergent container body 163a may be pulled forward together with the handle 163b and withdrawn.

The detergent container body 163a may be formed with the detergent container rails. The detergent container rails may guide a movement of the detergent container body 163a.

For example, the detergent container rails may be provided in the form of grooves or ribs in the forward/rearward direction on the lateral surfaces of the detergent container body 163a based on the leftward/rightward direction.

With this configuration, in case that the user couples the detergent container 163 to the housing 110, the detergent container 163 may be coupled at an exact position, and the washing water may be prevented from leaking out.

Meanwhile, although not illustrated, rails may be formed on the housing 110 while corresponding to the detergent container rails. The rails may be formed to correspond to shapes and positions of the detergent container rails.

The wastewater container 166 may provide a space that stores the washing water that has been used to wash the rag 242. After the rag 242 is washed, the washing water discharged to the upper surface of the washing plate 122 may flow downward along the inclination of the washing plate 122 and be discharged to the passing holes 122b. The washing water having passed through the passing holes 122b accumulates in the washing tub 128. In addition, the washing water accumulating in the washing tub 128 may be introduced into a wastewater suction flow path 166b through a wastewater inlet port 166a, pass through the wastewater suction flow path 166b, and be introduced into the wastewater container 166. That is, the liquid having passed through the washing plate 122 may flow along the washing tub 128 and be discharged through the wastewater inlet port 166a.

Meanwhile, the wastewater suction flow path 166b is formed in a wastewater suction pipe, the wastewater inlet port 166a is formed at one end of the wastewater suction pipe, and the other end of the wastewater suction pipe communicates with the wastewater container 166. In this case, the wastewater suction pipe may be disposed to pass through a lower side of an outside air supply module 171.

The washing water stored in the wastewater container 166 may be discharged to the water drain pipe 25 of the kitchen cabinet 2 through a wastewater discharge flow path 167. One end of the wastewater discharge flow path 167 may be connected to the wastewater container 166, and the other end of the wastewater discharge flow path 167 may be connected to the water drain pipe 25. In this case, the washing water stored in the wastewater container 166 may be allowed to flow through the wastewater and discharge flow path 167 by the pump (not illustrated) discharged to the water drain pipe 25.

The wastewater discharge flow path 167 connected to the wastewater container 166 may be connected to the upstream side 25b based on the U-trap 25a of the water drain pipe 25 of the kitchen cabinet 2. This is because an offensive odor or fluid in the water drain pipe 25 may flow reversely to the wastewater discharge flow path 167 in case that the wastewater discharge flow path 167 is connected to the downstream side 25c based on the U-trap 25a of the water drain pipe 25.

In addition, the rag washing part 160 may include a check valve (not illustrated). The check valve may prevent the fluid in the water drain pipe 25 from flowing reversely to the wastewater discharge flow path 167. The check valve may be provided at the other end of the wastewater discharge flow path 167 connected to the water drain pipe 25.

### Rag Drying Part

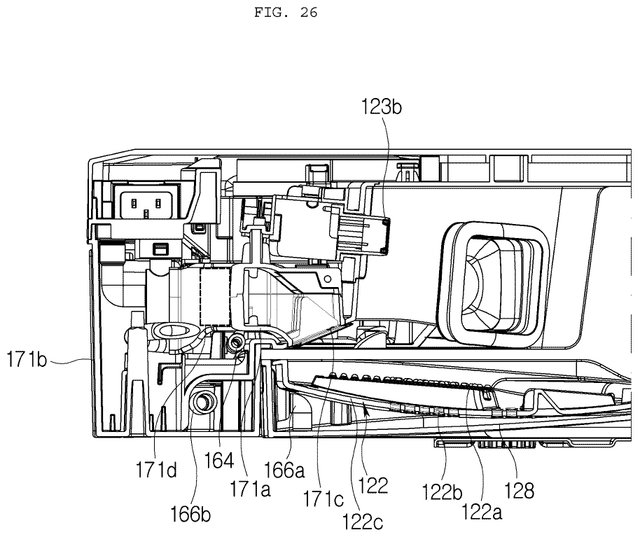

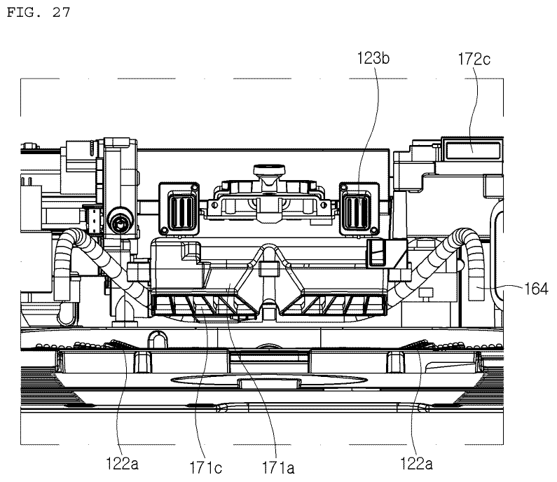

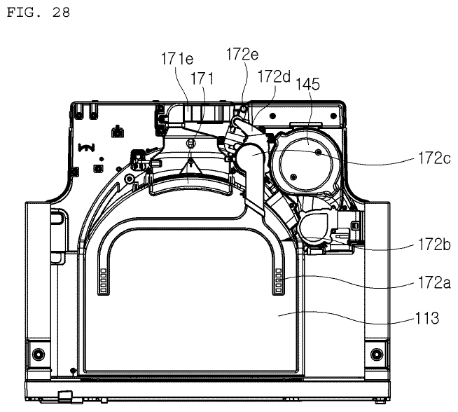

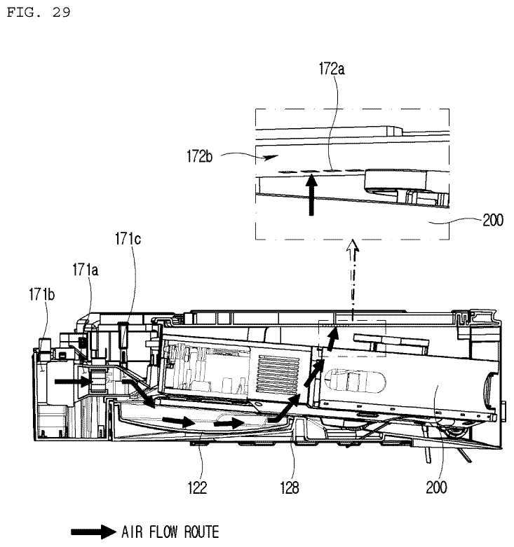

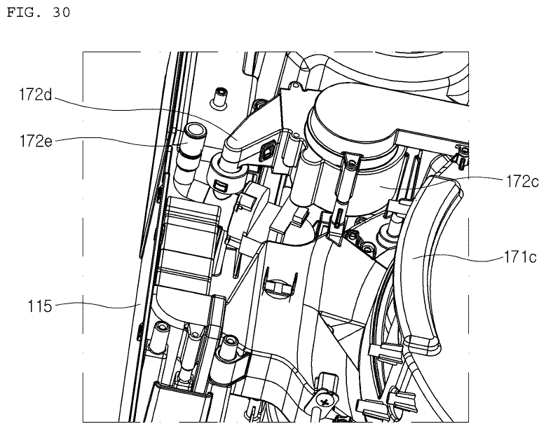

With reference to FIGS. 26 to 30, the robot cleaner station 100 according to the embodiment of the present disclosure may include the drying part 170. In this case, the drying part 170 may dry the rag 242 of the robot cleaner 200, which has been washed by the rag washing part 160, or the rag 242 that is wet after a water cleaning process.

The drying part 170 may include the outside air supply module 171 and an air discharge part 172.

The outside air supply module 171 may heat air existing outside the housing 110 and supply the heated air to the accommodation space S. The outside air supply module 171 may include an outside air supply flow path 171a, an outside air inlet port 171b, the outside air discharge part 171c, a heater 171d, and a blower fan (not illustrated).

The outside air supply module 171 is formed with the outside air supply flow path 171a. The outside air supply flow path 171a may allow outside air to flow to the outside air discharge part 171c.

The outside air supply flow path 171a may connect an external space of the housing 110 and the accommodation space. One side of the outside air supply flow path 171a may communicate with the external space through the outside air inlet port 171b, and the other side of the outside air supply flow path 171a may communicate with the accommodation space S through the outside air discharge part 171c.

The outside air inlet port 171b may be formed in a rear surface of the housing 110. The outside air inlet port 171b may be provided as a plurality of outside air inlet ports 171b formed in the rear surface of the housing 110. The air existing outside the housing 110 may be introduced into the outside air supply flow path 171a through the outside air inlet port 171b. Therefore, the air existing outside the housing 110 may be introduced into the housing 110.

At least a part of the outside air discharge part 171c may be disposed above the washing plate 122. The outside air discharge part 171c may be open in a direction facing the washing plate 122. The outside air discharge part 171c may be provided as a pair of outside air discharge parts 171c opened at lower sides thereof.

The outside air discharge part 171c may discharge the air having passed through the outside air supply flow path 171a. The outside air discharge part 171c may discharge the air heated by the heater 171d. For example, the outside air discharge part 171c may be formed with an outside air outlet port.

Meanwhile, in the present embodiment, a diameter of the outside air discharge part 171c in the leftward/rightward direction may decrease forward. That is, in the present embodiment, in the case of a diameter of the outside air discharge part 171c in the leftward/rightward direction, a width of a rear end may be larger than a width of a front end. Therefore, it is possible to uniformly dry the entire rag 242 even though the rag 242 having a circular plate-like shape rotates during the drying process.

Meanwhile, the outside air discharge part 171c may be provided with a grille configured to guide a discharge direction of air. Therefore, it is possible to prevent the heated air from being concentratedly discharged to a specific position.

The outside air discharge part 171c may be open toward the upper surface of the rag 242 in the state in which the rag 242 is seated on the washing plate 122. Therefore, the outside air discharge part 171c may be positioned adjacent to the rag 242 and open downward, such that the air discharged from the outside air discharge part 171c may flow toward the rag 242.

In particular, the outside air discharge part 171c of the present embodiment may have a shape inclined downward toward the front side of the robot cleaner station 100. Therefore, an end of the outside air discharge part 171c, from which the air is discharged, may be formed to be inclined at a predetermined angle with respect to the ground surface. In this case, the angle may be 90 degrees or less. Therefore, the outside air discharge part 171c may discharge the air in a direction intersecting the direction in which the flow guide surface 122c is formed.

A blower fan 171e may be disposed in the outside air supply flow path 171a and blow the air toward the accommodation space S. When the blower fan (not illustrated) operates, the air introduced through the outside air inlet port 171b may be heated by the heater 171d and discharged to the accommodation space S through the outside air discharge part 171c.

The heater 171d may be disposed in the outside air supply flow path 171a and heat the air flowing through the outside air supply flow path 171a. The heater 171d may heat the air discharged through the outside air discharge part 171c.

The air heated by hot air discharged from the outside air supply module 171 may be discharged through the air discharge part 172.

At least a part of the air discharge part 172 may be disposed above the accommodation space S.

The air heated by hot air discharged from the outside air supply module 171 may supply heat to the rag 242 of the robot cleaner 200. Therefore, moisture, which is absorbed by the rag 242 and remains in the rag 242, may be vaporized by absorbing heat from the air. The vaporized moisture may flow in the accommodation space S. Therefore, the air in the accommodation space S may include the vaporized moisture, and humidity in the accommodation space S may be increased (hereinafter, the air including the vaporized moisture in the accommodation space S may be referred to as “wet vapor”).

Specifically, at least a part of the air discharge part 172 may be disposed on the upper cover 113, and the upper cover 113 may cover an upper side of the accommodation space S.

The air heated by hot air discharged from the outside air supply module 171 is in a state in which humidity is increased as moisture in the rag 242 is vaporized. Therefore, in case that the robot cleaner station 100 is disposed below the kitchen cabinet 2, wet vapor comes into contact with various types of components, such as the baseboard 26, of the kitchen cabinet 2, which adversely affects the components.

In this case, in the present embodiment, the upper cover 113 covers the upper side of the accommodation space S, and a door 126 covers a front side of the accommodation space S, such that the upper cover 113, together with the door 126, may prevent wet vapor in the accommodation space S from being discharged to the outside, thereby preventing the kitchen cabinet 2 from coming into contact with the wet vapor.

The air discharge part 172 may include an air suction port 172a, an air discharge duct 172b, and an air discharge fan 172c. The air suction port 172a may communicate with the accommodation space S. The air suction port 172a may be disposed at the upper side of the accommodation space S. The wet vapor in the accommodation space S may be discharged through the air suction port 172a.

The air suction port 172a may be disposed to be higher than the robot cleaner 200 from the ground surface in the state in which the robot cleaner 200 is seated on the seating part 120. Therefore, it is possible to improve efficiency in sucking vapor that is raised by convection while the rag is being dried.

For example, the air suction port 172a may be formed in the upper cover 113. In this case, the upper cover 113 may be formed in a shape in which two or more plates are superimposed. Among the two or more plates, the air suction port 172a may be formed in a lowermost plate, and a flow path, which communicates with the air suction port 172a, may be formed between the plates, thereby constituting the air discharge duct 172b.

In another example, the air suction port 172a may be formed in the air discharge duct 172b provided in the form of a circular or quadrangular pipe, and the air discharge duct 172b may be coupled to the upper cover 113.

With this configuration, when the upper cover 113 is separated, the air discharge duct 172b may be separated together with the upper cover 113. In case that the upper side of the robot cleaner station 100 needs to be opened to perform maintenance or the like, an operator may remove even the air discharge duct 172b by simply lifting the upper cover 113.

A distance from the outside air outlet port 171c to the air suction port 172a may be longer than a distance from the outside air outlet port 171c to the rag 242. This is intended to prevent a situation in which the heated air discharged from the outside air discharge port 171c is sucked directly into the air suction port 172a without being sufficiently supplied to the rag 242, which causes waste of energy.

The air discharge duct 172b may connect the air suction port 172a and the air discharge fan 172c and communicate with the water drain pipe 25 of the kitchen cabinet 2. The air discharge duct 172b may guide the wet vapor, which is discharged through the air suction port 172a, to the water drain pipe 25.

An air discharging flow path may be formed in the air discharge duct 172b and communicate with the air suction port 172a.

The air discharging flow path may refer to a flow path through which the air introduced through the air suction port 172a flows. For example, the air discharging flow path may include an internal space of the air discharge duct 172b, an internal space of a housing of the air discharge fan 172c, and an internal space of a check valve 172d. One side of the air discharging flow path may communicate with the air suction port 172a, and the other side of the air discharging flow path may communicate with an air discharge port 172e.

The air discharge fan 172c may induce a flow of air flowing from the air suction port 172a toward the water drain pipe 25. The air discharge fan 172c may generate an airflow in order to suck the wet vapor, which exists in the accommodation space S, into the air suction port 172a and then discharge the wet vapor to the outside through the air discharge duct 172b.

The air discharge fan 172c may include an air discharge fan housing, a fan motor, and an impeller. A flow path may be formed in the air discharge fan housing and communicate with the air discharge duct 172b. When the air discharge fan impeller is rotated by an operation of the air discharge fan motor, the air in the accommodation space S or the housing 110 may be introduced into the air discharge duct 172b, pass through an interior of the air discharge fan housing, and then be discharged to the air discharge port 172e.

Meanwhile, in the present embodiment, the air discharge fan 172c may be coupled to the outside air supply module 171. Specifically, the air discharge fan housing of the air discharge fan 172c may be coupled to the outside air supply module 171 and configured as a single assembly. Therefore, it is possible to minimize a space occupied by the outside air supply module 171 and the air discharge part 172.

When the air discharge fan 172c operates, the air in the accommodation space S may be introduced into the air suction port 172a. The air introduced into the air suction port 172a may be discharged to the water drain pipe 25.

The drying part 170 may include the check valve 172d configured to prevent the fluid in the water drain pipe 25 from reversely flowing to the air discharge duct 172b. The check valve 172d may be disposed rearward of the air discharge fan 172c. The check valve 172d may communicate with an internal space of the air discharge fan 172c. The check valve may prevent the fluid in the water drain pipe 25 from reversely flowing to the air discharge part 172.

The air discharge part 172 may be connected to a downstream side of the water drain pipe 25 based on the U-trap 25a. Specifically, the air discharge port 172e may be connected to the water drain pipe 25 by means of a flow path member. For example, the flow path member may be a hose. This is because hot air discharged through the air discharge part 172 cannot pass through the water drain pipe 25 because of the water accumulated in the U-trap 25a in case that the air discharge part 172 is connected to the upstream side 25b based on the U-trap 25a of the water drain pipe 25. In addition, this is intended to prevent a situation in which offensive odor, which is generated from the air discharged from the air discharge part 172, reversely flows along the water drain pipe 25 and spreads toward the kitchen.

The wet vapor, which is discharged to the air suction port 172a and passes through the air discharge fan 172c, may be discharged to the outside of the housing 110 along the flow path member via the air discharge port 172e.

In this case, the flow path member may penetrate any one of two opposite sides of an outer wall thereof and be connected to the water drain pipe 25.

### Drawer

In case that the charging stand for the robot cleaner is disposed below the kitchen cabinet, the exposure to the outside is minimized, which may provide an interior effect. However, there is a limitation in that it may be difficult for the user to extract and repair the robot cleaner and the charging stand in case that the robot cleaner is broken down in the state in which the robot cleaner is placed below the kitchen cabinet or in case that the charging stand for the robot cleaner is broken down. In order to cope with the above-mentioned limitation, in the present disclosure, the robot cleaner station 100 may be further equipped with the drawer 190.

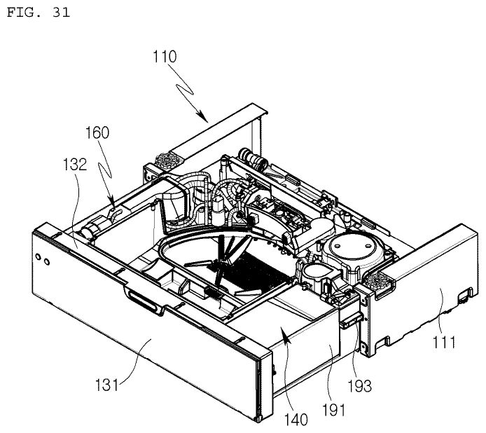

In this regard, FIG. 31 is a view for explaining a state in which the drawer is withdrawn from the robot cleaner station according to the embodiment of the present disclosure.

The drawer 190 of the robot cleaner station 100 according to the embodiment of the present disclosure will be described below with reference to FIG. 31.

The robot cleaner station 100 according to the embodiment of the present disclosure may further include the drawer 190 configured to be withdrawn from the housing 110.

The drawer 190 may move relative to the housing 110. For example, the housing 110 may be fixedly coupled to the kitchen cabinet 2, and the drawer 190 may be withdrawn forward from the housing 110.

In this case, the drawer 190 may be withdrawn in the state in which the seating part 120 is provided in the drawer 190. With this configuration, when the drawer 190 is withdrawn, the seating part 120 and/or the robot cleaner 200 may be withdrawn from the kitchen cabinet 2 to the outside.

In this case, the upper cover 113 may be exposed to the outside when the drawer 190 is withdrawn from the housing 110 in the state in which the door 131 closes the inlet/outlet 127. In this case, when the upper cover 113 is disassembled, the robot cleaner 200 may be exposed to the outside.

Therefore, according to the present embodiment, in case that the robot cleaner station 100 is required to be subjected to maintenance such as repair or cleaning, the user may easily withdraw the seating part 120 and/or the robot cleaner 200 by means of the drawer 190 and expose the constituent elements in the robot cleaner station 100 or the robot cleaner 200.

The drawer 190 includes drawer sidewalls 191, fitting parts 192, and drawer rails 193.

The drawer sidewalls 191 are configured to be movable relative to the outer wall surfaces of the housing 110. For example, the pair of drawer sidewalls 191 may be disposed to face the pair of outer walls of the housing 110.

In this case, the pair of drawer sidewalls 191 may be disposed to be closer to the inside of the robot cleaner station 100 than the pair of outer walls of the housing 110. That is, the pair of drawer sidewalls 191 may be disposed to be closer to the seating part 120 than the pair of outer walls of the housing 110.

Meanwhile, the dust collection part 140 and/or the rag washing part 160 may be disposed between the drawer sidewall 191 and the seating part 120.

With this configuration, the dust collection part 140 and the rag washing part 160 may be disposed by utilizing a minimum horizontal space.

The drawer rail 193 may be disposed on the drawer sidewall 191 and guide a movement of the drawer sidewall 191. The drawer rail 193 may be fixedly coupled to or integrated with the drawer sidewall 191. The drawer rail 193 may be coupled to the rail installed on the outer wall 111 of the housing 110 and guide a movement route of the drawer sidewall 191. Meanwhile, the present disclosure discloses that the rails are provided on the drawer 190 and the housing 110. However, the present disclosure is not necessarily limited to the rail shape. A roller, a guide groove, a guide rib, or the like, which may be substituted for the rail, may be included.

### Control Configuration

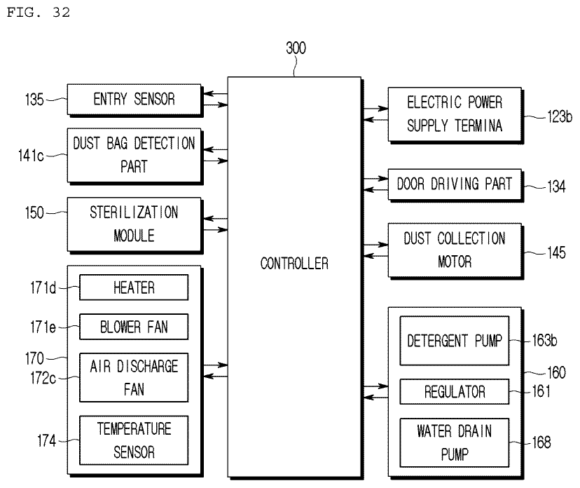

FIG. 32 is a block diagram for explaining a control configuration of the cleaner station according to the embodiment of the present disclosure.

The control configuration of the robot cleaner station 100 of the present disclosure will be described below with reference to FIG. 32.

The cleaner station 100 according to the embodiment of the present disclosure further includes a controller 300 configured to control the seating part 120, the dust collection motor 145, the rag washing part 160, and the drying part 170.

The controller 300 may include a printed circuit board and elements mounted on the printed circuit board.

The controller 300 may receive a signal from the entry sensor 135 and control the door driving part 134.

The controller 300 may detect the approach of the robot cleaner 200 and control the door driving part 134 to rotate the door 131. Specifically, the controller 300 may detect, by means of the entry sensor 135, whether the robot cleaner 200 enters. Specifically, the controller 300 may open the inlet/outlet 127 by rotating the door 131 when a distance between the robot cleaner 200 and the door 131 is shorter than a preset distance. In addition, the controller 300 may close the inlet/outlet 127 by rotating the door 131 when the robot cleaner 200 is coupled to the seating part 120.

When electric power is supplied to the battery of the robot cleaner 200 from the electric power supply terminal 123b, the controller 300 may determine that the robot cleaner 200 is coupled to the seating part 120.

The controller 300 may operate the dust collection motor 145 to suck dust from the inside of the dust bin 220 of the robot cleaner 200.

Meanwhile, the robot cleaner station 100 according to the embodiment of the present disclosure may include a memory (not illustrated). The memory may include various data for operating or driving the robot cleaner station 100.

Meanwhile, the robot cleaner station 100 according to the embodiment of the present disclosure may include a communication part 310. The communication part 310 may support wireless communication with other devices, such as the robot cleaner 200 or a terminal (not illustrated), existing outside the robot cleaner station 100. As a wireless communication module for wireless communication support, a near-field communication module or a far-field communication module may be provided.

For example, a short-range communication may be Bluetooth communication, near field communication (NFC) communication, or the like.

For example, the far-field communication may be wireless LAN (WLAN), digital living network alliance (DLNA), wireless broadband (Wibro), world interoperability for microwave access (Wimax), global system for mobile communication (GSM), code division multi-access (CDMA), code division multi-access 2000 (CDMA 2000), enhanced voice-data optimized or enhanced voice-data only (EV-DO), wideband CDMA (WCDMA), high-speed downlink packet access (HSDPA), high-speed uplink packet access (HSUPA), IEEE 802.16, long term evolution (LTE), long term evolution-advanced (LTEA), wireless mobile broadband service (WMBS), Bluetooth low energy (BLE), Zigbee, radio frequency (RF), long range LoRa, and the like.

Meanwhile, the controller 300 may identify, by means of the communication part 310, whether the robot cleaner 200 is positioned outside the housing 110.

The controller 300 may control the rag washing part 160.

Specifically, the controller 300 may control a detergent pump 163b. The controller 300 may operate the detergent pump 163b to discharge the detergent, which is stored in the detergent container 163, to the rag 242.

In addition, the controller 300 may control the regulator 161. The controller 300 may operate the regulator 161 to adjust the amount of purified water to be discharged to the rag 242.

In addition, the controller 300 may control a water drain pump 168. The controller 300 may operate the water drain pump 168 to drain wastewater produced after the rag 242 is washed.

The controller 300 may control the drying part 170.

Specifically, the controller 300 may control the heater 171d. The controller 300 may operate the heater 171d to heat air to be discharged to the rag 242.

In addition, the controller 300 may control the blower fan 171e. The controller 300 may operate the blower fan 171e to discharge air to the rag 242.

In addition, the controller 300 may control the air discharge fan 172c. The controller 300 may operate the air discharge fan 172c to discharge the air, which has been used to dry the rag 242, to the outside.

In addition, the controller 300 may receive a signal from a temperature sensor 174. The controller 300 may measure a temperature of air in the housing 110 based on temperature information received from the temperature sensor 174. Further, the controller 300 may sterilize bacteria present in the rag 242 by controlling the operation of the heater 171d based on temperature information received from the temperature sensor 174.

In addition, the controller 300 may receive a signal from a humidity sensor 175. The humidity sensor 175 may be disposed in the air discharge duct 172b. The controller 300 may calculate a degree to which the rag 242 is dried based on humidity information received from the humidity sensor 175. Further, the controller 300 may dry the rag 242 by controlling the operation of the heater 171d based on the humidity information received from the humidity sensor 175. In addition, the controller 300 may rotate the rag 242 by operating the rotary plate motor 243 of the robot cleaner 200 by controlling the controller of the robot cleaner 200 based on the humidity information received from the humidity sensor 175.

In addition, the controller 300 may receive a signal from a turbidity sensor 169. The turbidity sensor 169 may be disposed in the wastewater discharge flow path 167. The controller 300 may calculate a degree to which the rag 242 is washed based on turbidity information received from the turbidity sensor 169. Further, the controller 300 may wash the rag 242 by controlling the operation of the regulator 161 based on the turbidity information received from the turbidity sensor 169. In this case, the controller 300 may control an operating time of the regulator 161 based on the turbidity information. In addition, the controller 300 may rotate the rag 242 by operating the rotary plate motor 243 of the robot cleaner 200 by controlling the controller of the robot cleaner 200 based on the turbidity information received from the turbidity sensor 169.

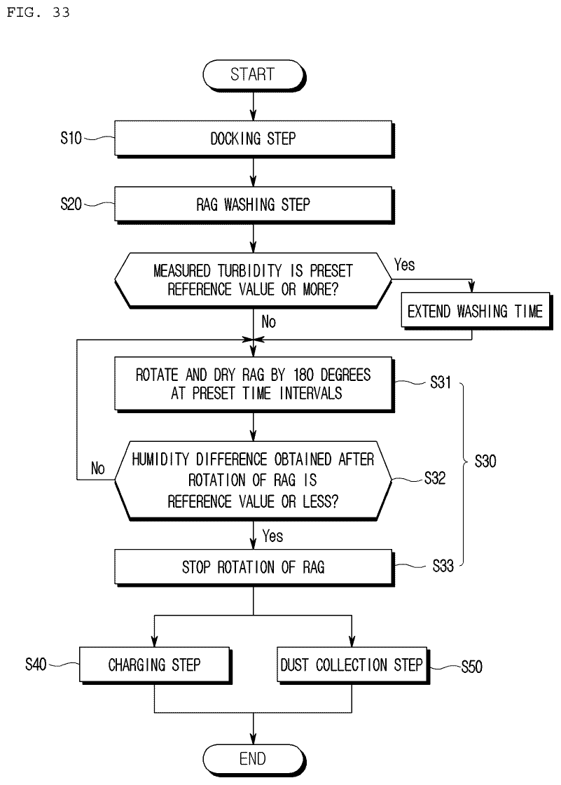

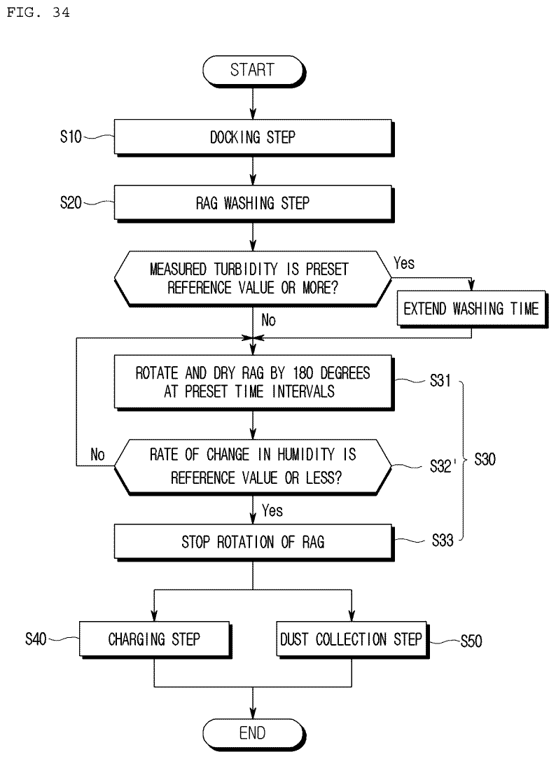

Meanwhile, FIG. 33 is a flowchart for explaining a method of controlling the robot cleaner station according to the embodiment of the present disclosure, and FIG. 34 is a flowchart for explaining a method of controlling the robot cleaner system according to another embodiment of the present disclosure.

The method of controlling the robot cleaner system according to the embodiment of the present disclosure will be described below with reference to FIGS. 32 and 33.

The method of controlling the robot cleaner station according to the embodiment of the present disclosure includes a docking step S10, a rag washing step S20, and a rag drying step S30.

During the process of cleaning the floor, dust may be stored in the dust bin 220 of the robot cleaner 200, water stored in the water container 230 may be used, and the rag 242 may be contaminated.

In this case, in case that the robot cleaner 200 cleans all preset cleaning regions, the dust bin 220 is fully filled with dust, the water stored in the water container 230 is completely used, or electric power in the battery of the robot cleaner 200 is almost completely consumed, the controller (not illustrated) of the robot cleaner 200 may control the robot cleaner 200 so that the robot cleaner 200 returns back to the robot cleaner station 100.

Therefore, when the robot cleaner 200 approaches the robot cleaner station 100, the method of controlling the robot cleaner station 100 according to the embodiment of the present disclosure may be performed.

First, in the docking step S10, the robot cleaner 200, which has performed the cleaning process, is coupled to the robot cleaner station 100.

In the docking step S10, the controller 300 may detect the approach of the robot cleaner 200 by using the entry sensor 135 and rotate the door 131 by controlling the door driving part 134. Specifically, the controller 300 may open the inlet/outlet 127 by rotating the door 131 when a distance between the robot cleaner 200 and the door 131 is shorter than a preset distance. Therefore, the controller 300 may operate the door driving part 134 in one direction and rotate the door 131 so that the door 131 opens the inlet/outlet 127.

Thereafter, the robot cleaner 200 may climb the base 121 of the seating part 120. When the robot cleaner 200 climbs the base 121, the electric power supply terminal 123b may come into contact with and be electrically connected to the charging terminal 280 of the robot cleaner 200.

In addition, the water supply nozzle 123c may be connected to the supply part 231 of the water container 230 of the robot cleaner 200.

In addition, the rag 242 of the robot cleaner 200 may be disposed above the washing plate 122, and at least a part of a lower end of the rag 242 may come into contact with the washing protrusion 122a of the washing plate 122.

In this case, when electric power is supplied to the battery of the robot cleaner 200 from the electric power supply terminal 123b, the controller 300 may determine that the robot cleaner 200 is coupled to the seating part 120.

Further, when the controller 300 determines that the robot cleaner 200 is coupled to the seating part 120, the controller 300 may close the inlet/outlet 127 by rotating the door 131 by operating the door driving part 134 in a direction opposite to one direction.

In the rag washing step S20, the controller 300 may wash the rags 242 of the robot cleaner after the docking step S10.

In the state in which the rag 242 is disposed above the washing plate 122, the controller 300 may discharge the purified water, which is introduced from the water supply pipe, to the rag 242 by operating the regulator 161.

In this case, whether to input the detergent may vary depending on mode selection performed by the user.

Specifically, the controller 300 may operate the detergent pump 163b to discharge the detergent, which is stored in the detergent container 163, to the rag 242. In this case, the controller 300 may simultaneously operate the detergent pump 163b and the regulator 161. Of course, the controller 300 may operate the detergent pump 163b and the regulator 161 at a time interval. Therefore, the purified water and the detergent may be supplied to the rag 242 simultaneously or at a time interval.

Meanwhile, the controller 300 may control the rotary plate motor 243 of the robot cleaner 200 by means of the communication part 310. Therefore, the rag 242 may be rotated in a state in which the purified water and the detergent have been supplied to the rag 242 (i.e., the rag 242 is wet) or a state in which the purified water and the detergent are being supplied to the rag 242.

In this case, when the rotary plate motor 243 rotates in one direction, the rotary plate 241 may move downward. Therefore, the rag 242 and the washing plate 122 may come into contact with each other.

Therefore, friction may occur between the rag 242 and the washing protrusion 122a of the washing plate 122, such that debris attached to the rag 242 may be removed. This may provide an effect similar to that obtained by applying a detergent to laundry and then rubbing and washing the laundry during a laundering process.

Thereafter, the controller 300 may rotate the rag 242 in a state in which the controller 300 stops the operation of the detergent pump 163b and operates only the regulator 161. Therefore, the detergent remaining in the rag 242 may be washed away. This provides an effect similar to that obtained by rinsing a detergent during a laundering process.

Alternatively, the controller 300 may operate the regulator 161 and then rotate the rag 242. This may provide an effect similar to that obtained by washing laundry in flowing water.

Meanwhile, in the rag washing step S20, the controller 300 may operate the water drain pump 168. In this case, the controller 300 may simultaneously operate the regulator 161 and the water drain pump 168. Of course, the controller 300 may operate the water drain pump 168 when a preset period of time has elapsed after the operation of the regulator 161. Therefore, it is possible to discharge wastewater produced after the rag 242 is washed.

In this case, the controller 300 may receive turbidity information related to the wastewater being discharged through the turbidity sensor 169. Therefore, the controller 300 may calculate a degree to which the rag 242 is washed based on the turbidity information received from the turbidity sensor 169.

Further, the controller 300 may determine whether to additionally wash the rag 242 by controlling the operation of the regulator 161 based on the turbidity information received from the turbidity sensor 169. That is, in case that the received the turbidity is higher than preset reference turbidity, controller 300 may determine that the rag 242 needs to be additionally washed, and the controller 300 may extend the operating time of the regulator 161. In addition, the controller 300 may extend, by means of the communication part 310, the period of time for which the controller 300 rotates the rotary plate motor 243 of the robot cleaner 200. In addition, the controller 300 may extend a period of time for operating the water drain pump 168.

In the rag drying step S30, the controller 300 may dry the rag 242 by supplying heated air to the rag 242 after the rag washing step S20.

In the rag drying step S30, the controller 300 may dry the rag 242 by operating the heater 171d and the blower fan 171e for a preset period of time. In this case, the controller 300 may operate the heater 171d and the blower fan 171e in the state in which the door 131 is closed. Therefore, heat may accumulate in the housing 110, thereby sterilizing the rag 242 and shortening a period of time for drying the rag 242.

In this case, the controller 300 may adjust a drying temperature and a drying time in accordance with the mode selection performed by the user.

Meanwhile, in the rag drying step S30, the controller 300 may control the rotary plate motor 243 of the robot cleaner 200 by means of the communication part 310.

In this case, the controller 300 may rotate the rotary plate 241 at a preset time interval by controlling the rotary plate motor 243 (S31). Specifically, the controller 300 may rotate the rotary plate 241 by 180 degrees at a preset time interval by controlling the rotary plate motor 243. For example, the controller 300 may rotate the rotary plate 241 by 180 degrees at intervals of 30 minutes.

Therefore, according to the present disclosure, the controller 300 may uniformly dry the entire rag 242 by rotating the rag 242 by 180 degrees in a predetermined cycle.

In addition, it is possible to prevent a problem, such as microorganism proliferation, caused when a part of the rag 242 is not completely dried.

In addition, it is possible to improve energy efficiency by shortening the amount of time required to completely dry the rag 242.

Meanwhile, according to the embodiment, the controller 300 may move the rotary plate 241 upward and then rotate the rotary plate 241. Therefore, the rag 242 may rotate in a state in which the rag 242 is spaced apart from the washing plate 122. In this case, a rotation direction of the rotary plate motor 243 may be a direction opposite to the rotation direction of the rotary plate motor 243 in the rag washing step S20.

Meanwhile, in the rag drying step S30, heated air in the housing 110 may be discharged to the outside.

Specifically, in the rag drying step S30, the controller 300 may discharge the heated air from the interior of the housing 110 to the outside by operating the air discharge fan 172c. Therefore, the heat accumulated in the housing 110 may be discharged to the outside, and water vapor may be discharged to the outside.

Therefore, it is possible to reduce the humidity in the housing 110, prevent the water vapor from being absorbed by the rag 242, and discharge odors, which are generated during the process of drying the rag 242, to the outside.

Meanwhile, in the rag drying step S30, the controller 300 may receive humidity information of air being discharged from the humidity sensor 175. Therefore, the controller 300 may calculate a degree to which the rag 242 is dried based on the humidity information received from the humidity sensor 175.

Further, the controller 300 may determine whether to stop the rotation of the rotary plate 241 based on the humidity information received from the humidity sensor 175.

The controller 300 may determine whether to further rotate the rotary plate 241 based on a difference between humidity obtained before the rotary plate 241 is rotated by 180 degrees and humidity obtained after the rotary plate 241 is rotated by 180 degrees (S32). Specifically, in case that the difference between the humidity obtained before the rotary plate 241 is rotated by 180 degrees and the humidity obtained after the rotary plate 241 is rotated by 180 degrees is a preset reference value or less, the controller 300 may determine that it is not necessary to rotate the rotary plate 241 any further.

Therefore, the controller 300 may stop the rotation of the rotary plate 241 (S33). For example, in case that the humidity difference, which is obtained by measuring the humidity at intervals of 30 minutes, is 5% or less, the controller 300 may stop the rotation of the rotary plate 241.

Meanwhile, with reference to FIG. 34, in another embodiment of the present disclosure, the controller 300 may determine whether to further rotate the rotary plate 241 based on a rate of change in humidity (S32″). Specifically, the controller 300 may measure the humidity at a preset time interval and calculate a rate of change in humidity with respect to a previously measured humidity. In case that the calculated rate of change is a preset reference value or less, the controller 300 may determine that it is not necessary to rotate the rotary plate 241 any further.

Therefore, the controller 300 may stop the rotation of the rotary plate 241 (S33). For example, in case that an absolute value of a value ((A−B)/A) obtained by dividing a difference (A−B) between a previously measured humidity (A) and a currently measured humidity (B) by the previously measured humidity (A) is smaller than 0.01,

|(A−B)/A|<0.01
the controller 300 may stop the rotation of the rotary plate 241.

In this case, the controller 300 may detect that the rag 242 has been uniformly dried.

Therefore, it is possible to detect a time point at which the rag 242 is uniformly dried and to set the amount of time required for the rag drying step S30 based on the time point, thereby improving drying efficiency.

The controller 300 may perform a charging step S40 after the rag drying step S30. This is because there is a likelihood that the humidity in the housing 110 rapidly increases and electric leakage occurs between the electric power supply terminal 123b and the charging terminal 280 of the robot cleaner 200 in case that the rag washing step S20 is performed in a space sealed by the housing 110.

In addition, the controller 300 may perform a dust collection step S50 after the rag drying step S30. In this case, the dust collection step S50 and the charging step S40 may be performed simultaneously.

In the docking step S10, when the robot cleaner 200 is coupled to the robot cleaner station 100, the dust discharge port 221 may face the dust passage hole 123a.

Thereafter, in the dust collection step S50, the robot cleaner station 100 may collect dust from the dust bin 220 of the robot cleaner 200.

In the dust collection step S50, the controller 300 may operate the dust collection motor 145 to collect dust from the interior of the dust bin 220 into the dust bag 143. In this case, the dust bin door 222, which has closed the dust discharge port 221, may be opened by the suction force of the dust collection motor 145, and dust stored in the dust bin 220 may be collected into the dust bag 143.

Therefore, it is possible to automatically empty the dust bin 220 of the robot cleaner 200.

While the present disclosure has been described with reference to the specific embodiments, the specific embodiments are only for specifically explaining the present disclosure, and the present disclosure is not limited to the specific embodiments. It is apparent that the present disclosure may be modified or altered by those skilled in the art without departing from the technical spirit of the present disclosure.

All the simple modifications or alterations to the present disclosure fall within the scope of the present disclosure, and the specific protection scope of the present disclosure will be defined by the appended claims.

### DESCRIPTION OF REFERENCE NUMERALS

1: Robot cleaner system
2: Kitchen cabinet
100: Robot cleaner station
110: Housing
120: Seating part
122: Washing plate
128: Washing tub
130: Door part
131: Door
140: Dust collection part
141: Dust collection part housing
144: Dust bag drawer
145: Dust collection motor
160: Rag washing part
169: Turbidity sensor
170: Rag drying part
171: Outside air supply module
172: Air discharge part
175: Humidity sensor
190: Drawer
200: Robot cleaner
241: Rotary plate
242: Rag
243: Rotary plate motor
300: Controller

What is claimed is:

1. A robot cleaner system comprising:
a robot cleaner station comprising a housing, a seating part disposed in the housing and comprising a washing plate on which a robot cleaner is seated, a rag washing part configured to wash a rag of the robot cleaner, and a rag drying part configured to dry the rag of the robot cleaner; and
a robot cleaner comprising a body, a rotary plate rotatably coupled to a lower side of the body, and the rag detachably coupled to the rotary plate,
wherein the rotary plate rotates while the rag drying part operates.

2. The robot cleaner system of claim 1, wherein the rotary plate moves upward while the rag drying part operates.

3. The robot cleaner system of claim 1, wherein the rag drying part comprises:
an outside air inlet port through which air existing outside the housing is introduced;
a heater configured to heat the air introduced through the outside air inlet port; and
an outside air outlet port through which the air heated by the heater is discharged to the rag, and
wherein the rotary plate rotates while the heater operates.

4. The robot cleaner system of claim 3, wherein the rag drying part further comprises a blower fan configured to provide a flow force to the air introduced through the outside air inlet port, and
wherein the rotary plate rotates while the blower fan operates.

5. The robot cleaner system of claim 1, wherein the rag drying part further comprises an air discharge fan configured to provide a flow force to air introduced through an air suction port, and
wherein the rotary plate rotates while the air discharge fan operates.

6. The robot cleaner system of claim 1, wherein the robot cleaner station further comprises a humidity sensor configured to measure humidity,
wherein the rag drying part further comprises:
an air suction port disposed in the housing and configured to suck air inside the housing; and
an air discharge duct through which the air sucked through the air suction port flows, and
wherein the humidity sensor is disposed in the air discharge duct.

7. The robot cleaner system of claim 6, wherein the rotation of the rotary plate is stopped when a rate of change in humidity measured by the humidity sensor is a preset reference value or less.

8. The robot cleaner system of claim 1, wherein the robot cleaner station is configured such that the rag drying part operates after the rag washing part operates, and the rotary plate rotates while the rag washing part operates.

9. The robot cleaner system of claim 8, wherein a height of the rotary plate while the rag drying part operates is higher than a height of the rotary plate while the rag washing part operates.

10. The robot cleaner system of claim 8, wherein the robot cleaner station further comprises a turbidity sensor configured to measure turbidity of a liquid, and
wherein a rotation time of the rotary plate increases when the turbidity measured by the turbidity sensor is a preset reference value or more.

11. The robot cleaner system of claim 8, wherein the rag washing part comprises a regulator configured to adjust a flow rate of a liquid supplied from a water supply pipe, and
wherein the rotary plate rotates while the regulator operates.

12. A robot cleaner comprising:
a body;
a rotary plate rotatably coupled to a lower side of the body; and
a rag detachably coupled to a lower side of the rotary plate,
wherein the rag is positioned above a washing plate of a robot cleaner station and configured to rotate while heated air is introduced.

13. The robot cleaner of claim 12, wherein the rag moves upward when the heated air is introduced.
